(19) United States
(12) Patent Application Publication
(10) Pub. No.: US 2012/0192151 A1
(43) Pub. Date: Jul. 26, 2012

(54) SOFTWARE DEVELOPMENT TOOL

(75) Inventors: Stephen Maxwell Parkes, Angus (GB); Craig Douglas Ramsay, Perth & Kinross (GB)

(73) Assignee: THE UNIVERSITY OF DUNDEE, Dundee (UK)

(21) Appl. No.: 13/322,528

(22) PCT Filed: May 26, 2010
(86) PCT No.: PCT/GB2010/001050

§ 371 Date: Apr. 4, 2012

(30) Foreign Application Priority Data
May 26, 2009 (GB) 0908913.7

(51) Int. Cl. G06F 9/44

(52) U.S. Cl. 717/120

(57) ABSTRACT

A method for improving the development and/or review of a computer program. The method comprises the steps of: adapting one or more design side components of the computer program to send and receive information on changes that occur therein; adapting one or more code side components of the computer program to send and receive information on changes that occur therein; synchronising design side components and code side components by conveying details of a change in a design side component to one or more corresponding code side components and to one or more corresponding design side components to update the contents of said components and by conveying details of a change in a code side component to one or more corresponding design side components and one or more corresponding code side components to update the contents of said components.

### INTRODUCTION

The present invention relates to an improved software development tool and method.

### BACKGROUND TO THE INVENTION

A variety of software development tools exist to support the software engineer in the design and implementation of software systems. Architectural modelling tools provide support for the architectural design of software systems using the Unified Modelling Language (UML). Integrated Development Environments (IDEs) provide support for writing the final program code and debugging it. Other tools exist for requirements management, testing and project management.

A skilled programmer can understand the program code using the IDE, however software systems can be highly complex and the use of accompanying design representations of the program code in both textual and graphical forms is helpful in order to visualise and organise the program structure and components. The key strength of architectural modelling tools is to allow the programmer to have an overview of the structure of the program. However, there is a tendency for software engineers to move directly from high level architectural design to detailed system programming, without any form of detailed design taking place.

Detailed design documentation of program code can easily get out of date (out of synchronisation) when compared to the program code itself. Programmers need to incorporate changes into the program code (the Code Side) but may often neglect to update the corresponding detailed design documentation (the Design Side) and/or lack effective tool support to do so. Furthermore there is a need for documentation throughout an entire software development life cycle, so that the documentation can be used for project reviews and information dissemination purposes all the way through the project. The documentation provided needs to be readily understandable by people other than expert software engineers, so that project managers and end users can help review the project and ensure that it is on schedule and the right functionality is being designed into the software. Continually providing and updating documentation so that it matches the latest version of the program code can be an extremely time consuming task. Making the documentation understandable by people other than expert software engineers is difficult.

### SUMMARY OF THE INVENTION

In accordance with a first aspect of the invention there is provided a method for improving the development and/or review of a computer program, the method comprising the steps of:

adapting one or more design side components of the computer program to send and receive information on changes that occur therein;
adapting one or more code side components of the computer program to send and receive information on changes that occur therein;
synchronising design side components and code side components by conveying details of a change in a design side component to one or more corresponding code side components and to one or more corresponding design side components to update the contents of said components and by conveying details of a change in a code side component to one or more corresponding design side components and one or more corresponding code side components to update the contents of said components.

Changes in the code side or design side may include changes in content, position and any other type of change which can be synchronised.

Optionally, the step of sending and receiving information from one or more code side components and one or more design side components comprises identifying and linking together corresponding code side and design side components such that the changes are sent from and to a corresponding code side and design side component only.

Optionally, the step of sending and receiving information from one or more code side components and one or more design side components comprises broadcasting information on changes to the design side and code side components.

Preferably, the sending and receipt of information from the one or more code side components and the one or more design side components is provided by a coordinating component which receives information from the code side and design side components.

Preferably, the coordinating component stores information on the components with which the software is operating and routes information between said components.

Preferably, the coordinating component receives events and forwards at least some of the received events to locations specified in a list of event listeners.

Preferably, the correspondence between a design side component and a code side component is provided by a Design-CodeRepresentation which provides an object which merges together design side and code side information.

Preferably, the Design-CodeRepresentation structure combines code-specific and design-specific information pertaining to detailed logic and/or structures within program code.

Preferably, the Design-CodeRepresentation is a source of consultation for both code-side and design-side components during synchronization tasks.

Preferably, the Design-CodeRepresentation is created or incrementally updated from a code side component by parsing of corresponding program code.

Preferably, the Design-CodeRepresentation is directly created or incrementally updated from a design side component.

Preferably, Design-CodeRepresentation information can be persisted to a storage medium for subsequent retrieval and processing at a later time.

Preferably, Design-CodeRepresentation information can be persisted to a storage medium through manual invocation or on an automated basis.

Preferably, program code information can be automatically generated from a Design-CodeRepresentation.

Preferably, generated program code can be provided to applications and storage mediums typically recognised as processing and holding program code.

Preferably, code side to design side synchronisation or code side to code side synchronisation is achieved by: retrieving code from the code side that is being edited;

creating or incrementally updating corresponding Design-CodeRepresentations from the code;
providing said Design-CodeRepresentations to design side components and other code side components;
said design side and code side components are updated.

Preferably, code side components record a previous state of the code.

Preferably, code side components record Design-CodeRepresentations which correspond to a previous state of the code.

Preferably, code side components determine whether elements of the code have been changed by comparing the current known state of the code with a previous state of the code.

Preferably, Design-CodeRepresentations are created or incrementally updated from program code only if it is determined that elements of the code have changed since a previous state of the code.

Preferably, code side components provide design side components and other code side components with Design-CodeRepresentations which correspond to a previous state of the code if it is determined that the code has not changed since a previous state of the code.

Alternatively, code side to design side synchronisation is achieved by: Selecting code files to be monitored;

Parsing the code files and creating an initial time stamp of file content and time of last modification;

Detecting changes to the selected code files as and when they occur;

Parsing files which have changed to create a set of Design-CodeRepresentations which reflect the changes; and updating the design side representations.

Preferably, the step of detecting changes to the selected code files comprises:

monitoring the files for changes using a timer to poll the timestamps of the selected code files and comparing them to previously known time stamps.

Optionally, the step of detecting changes to selected code files comprises, applying an event listener to detect changes in the selected code.

Preferably, the step of selecting the code files to be monitored comprises, creating code files with a synchronisation link between it and corresponding design side components.

Preferably, the program code files which are to be monitored can be selected by linking the program code files location to an application

Preferably, linking is achieved by specifying a location on disk and/or dragging and dropping the program code files onto an application which can then automatically deduce their location.

Optionally, the step of selecting the program code files to be monitored comprises specifying a containing folder and adding the selected code files to the containing folder wherein changes to the entire contents of folder will be monitored.

These changes can include adding or deleting files, renaming files, modifying the contents of files, addition of sub-folders and subsequent modifications to their contents.

Preferably, design side to code side synchronisation or design side to design side synchronisation is achieved by:

detecting changes in design information within a design side component;
creating or incrementally updating corresponding Design-CodeRepresentations from the design information;
providing said Design-CodeRepresentations to code side and design side components; said design side and code side components are updated.

Preferably, design side components will determine additions, modifications, and deletions to design information.

Preferably, design side components will apply additions, modifications and deletions to Design-CodeRepresentations corresponding to design information.

Preferably, design side components shall indicate the nature of modification, addition or deletion to code side and design side components.

Optionally, code to design and design to code synchronisation is achieved by: detecting changes to a code side or design side component;

identifying the Design-CodeRepresentation with one that reflects the previously known state of the code or design; and
merging the Design-CodeRepresentations together to create a new version of the Design-CodeRepresentation.

The newly merged version may be compared with subsequent versions to produce further updates.

Advantageously, this technique ensures that design information is not lost; something that is possible when a write/replace technique is used.

Preferably, the step of merging comprises:

parsing the code side component to produce a corresponding Design-CodeRepresentation object; and
comparing the Design-CodeRepresentation object from the code side component with a previous version of the Design-CodeRepresentation object in order to identify modifications so as to match the content of said Design-CodeRepresentation objects.

Preferably, matching is achieved by listing candidate Design-CodeRepresentation objects, scoring the candidate against a predetermined Design-CodeRepresentation, scoring a plurality of candidates and ranking said candidates.

Preferably, differences between a previous and current state of a Design-CodeRepresentation will be highlighted for review purposes, indicating additions, deletions, modifications, or where no changes have occurred.

Preferably, the proposed actions to take place during a merge regarding additions, modifications, or deletions shall be presented for confirmation to proceed prior to their taking place.

Preferably, one or more of the proposed actions to take place during a merge may be selected for omitting from the merge.

Preferably, one or more of the proposed actions to take place during a merge may be modified to achieve a different outcome during the merge.

Code-side and design-side components may comprise a mixture of graphical and textual representations and may be editable.

The design side component may be in the form of a flowchart representation of a software procedure or algorithm.

The design side component may be in the form of a state diagram representation of a software procedure or algorithm.

The design side component may be in the form of a data structure diagram illustrating the data structures defined in the program code.

The design side component may also be in the form of a pseudo-code representation of a software procedure or algorithm. The design side component may also be a combination of flow-charts, pseudocode, state-diagrams and data structure diagrams.

The different procedural views (flow-chart, pseudocode and state-diagrams) being used may all be synchronised with one another and with the program code.

The design side component may be generated automatically and dynamically from a pseudocode or other abstract textual representation of the design. The design side component may also be generated automatically and dynamically from the program code which may be entered in a Integrated Development Environment or retrieved from another source such as a program code file. Similarly, program code and code side information may be generated automatically and dynamically from a pseudocode or other abstract textual representation of the design. Program code and code side information may also be generated automatically and dynamically from a flowchart or other diagrammatical representation of the design.

Preferably, in the diagrammatical forms of design side component a symbolic representation is provided for various code constructs and which allows keywords to be derived from examining said constructs.

Preferably, diagrammatical forms of design side component incorporate drawing logic which automatically formats diagrams for the user and provides labour saving devices.

Preferably, textual forms of design side component incorporate logic which allows keywords to be derived from code constructs and for which specific representations may be provided.

Preferably, textual forms of design side component incorporate logic which automatically formats text for the user and provides labour saving devices.

Preferably, information which is specific to a code side or design component is contained in a wrapper which comprises additional data connected to or associated with a Design-CodeRepresentation.

Preferably, the wrapper contains component specific information.

Preferably, parsing comprises the steps of:

Detecting code structures within one or more lines of code;

Arranging the code structures with respect to one another to create linked design code representation of the code structures to reflect the content of the code and Creating a design view from the linked design-code representations.

In this context a code structure is any written information contained within the one or more lines of code which has a specific purpose and is distinguishable from other code structures.

Preferably, the method further comprises:

Detecting code structure in the form of comments within the lines of code

Recording said comment within a Design-CodeRepresentation

Detecting code associated with the comment and recording said code within the Design-CodeRepresentation in which said comment is recorded.

Preferably, the method further comprises the steps of: detecting code; detecting the absence of comments associated with said code; and automatically generating comment for inclusion in a design-coderepresentation associated with the parsed code.

More preferably, the method further comprises the steps of:

Creating a design code representation to hold the code property for the parsed code;

Applying comment generation logic to create a comment associated with the code.

Preferably, the comment generation logic will:

Examine the code associated with the Design-CodeRepresnetation;

Translate the lines of code into natural language;

Place the generated natural language in a text field of the Design-CodeRepresentation.

In this context a comment is any non-code item that has been included in the lines of code. This may be present to enhance the reader's understanding of the code.

Preferably, the method further comprises the steps of detecting code and comments within one or more lines of code;

Prioritising the detection of comments with respect to code in order to create Design-CodeRepresentations which are suitable for the creation of a design view from the Design-CodeRepresentations, such that the extent to which the functionality if the code is explained is optimised in the design view.

Preferably, the method of the present invention applies one or more rules to the analysis of the lines of code, said rules being designed to optimise the extent to which the functionality if the code is explained in the design view.

Preferably, the method further comprises the creation of tags which can be placed within code and which upon placement in the code determines how the associated code is parsed.

The present invention provides for the creation of a software development tool where the program code and detailed design information or design code are synchronised either automatically or on command by the user.

Synchronisation logic may be embedded within a software developer's IDE with direct access to program code content and the IDE's program code editor

Synchronisation logic may reside in a separate application which can gain access to program code either through an IDEs programmable interface or direct access to the files on disk which are created by the IDE. In this case it is possible to monitor the last modified time of files to detect potential changes to them requiring synchronisation.

Synchronisation logic may reside in additional tools commonly required during the software development process such as Computer Aided Software Engineering (CASE) Tools, Project management tools, testing tools, and configuration management tools. Synchronisation services shall be provided as embedded/integrated extensions to such tools and import and export of data to and from such tools.

Code side and design side components need not exist on the same user desktop. They may be distributed or remote.

The design side component can be generated automatically from legacy program code and where adequate detailed design information cannot be automatically extracted the necessary additional detailed design information may be requested.

A modified recursive descent algorithm may be used to extract the abstract design information from the program code.

Additional information on the state of the design or code may be included in the internal representation of the design. This information may relate to the state of progress with the software development and may include information on whether a block of code has been written, reviewed, and tested.

The additional information stored may include information about the semantic content of the abstract information, including whether the abstract information is likely to be incorrect.

The semantic content of the abstract information can be used to highlight potential problems with the abstract representation simultaneously in the available views of the software design, including program code, pseudocode, flow-chart, state-machine and data diagram.

The differences in abstract information between two program files can be highlighted in one or more of the possible views of the abstract information.

Preferably, other information pertinent to the development of a software system can be automatically generated from the internal representation of a design. This information may include testing data and project management data.

In accordance with a second aspect of the invention there is provided a computer program comprising program instructions for implementing the method of the first aspect of the invention.

In accordance with a third aspect of the invention there is provided a method of parsing comprising the steps of:

Detecting code structures within one or more lines of code;

Arranging the code structures with respect to one another to create linked design code representation of the code structures to reflect the content of the code and Creating a design view from the linked design-code representations.

In this context a code structure is any written information contained within the one or more lines of code which has a specific purpose and is distinguishable from other code structures.

Preferably, the method further comprises:

Detecting code structure in the form of comments within the lines of code

Recording said comment within a Design-CodeRepresentation

Detecting code associated with the comment and recording said code within the Design-CodeRepresentation in which said comment is recorded.

Preferably, the method further comprises the steps of: detecting code;

detecting the absence of comments associated with said code; and
automatically generating comment for inclusion in a design-coderepresentation associated with the parsed code.

More preferably, the method further comprises the steps of:

Creating a design code representation to hold the code property for the parsed code;

Applying comment generation logic to create a comment associated with the code.

Preferably, the comment generation logic will:

Examine the code associated with the Design-CodeRepresnetation;

Translate the lines of code into natural language;

Place the generated natural language in a text field of the Design-CodeRepresentation.

In this context a comment is any non-code item that has been included in the lines of code. This may be present to enhance the reader's understanding of the code.

Preferably, the method further comprises the steps of detecting code and comments within one or more lines of code;

Prioritising the detection of comments with respect to code in order to create Design-CodeRepresentations which are suitable for the creation of a design view from the Design-CodeRepresentations, such that the extent to which the functionality if the code is explained is optimised in the design view.

Preferably, the method of the present invention applies one or more rules to the analysis of the lines of code, said rules being designed to optimise the extent to which the functionality if the code is explained in the design view.

Preferably, the method further comprises the creation of tags which can be placed within code and which upon placement in the code determines how the associated code is parsed.

In accordance with a fourth aspect of the invention there is provided a computer program comprising program instructions for implementing the method of the first aspect of the invention.

In accordance with a fifth aspect of the invention there is provided a method of parsing comprising the steps of:

detecting code and comments within one or more lines of code;
Prioritising the detection of comments with respect to code in order to create Design-CodeRepresentations which are suitable for the creation of a design view from the Design-CodeRepresentations, such that the extent to which the functionality if the code is explained is optimised in the design view.

Preferably, the method of the present invention applies one or more rules to the analysis of the lines of code, said rules being designed to optimise the extent to which the functionality if the code is explained in the design view.

Preferably, the method further comprises the creation of tags which can be placed within code and which upon placement in the code determines how the associated code is parsed.

The method can be used in combination with the parsing method described in the second aspect of the invention where the features of that method are dependent upon those of the third aspect.

In accordance with a sixth aspect of the invention there is provided a computer program comprising program instructions for implementing the method of the first aspect of the invention.

### BRIEF DESCRIPTION OF THE DRAWINGS

The present invention will now be described by way of example only with reference to the accompanying drawings in which:

FIG. 1 is a block diagram which shows an example of system architecture for synchronisation, event broadcast and notification in accordance with the present invention;

FIG. 2 is an example of the internal content of a piece of code in accordance with the present invention;

FIG. 3 illustrates internal object-tree translation of program code text in accordance with the invention;

FIG. 4 illustrates the process for determining the ‘bounds’ of a procedure within program code in accordance with the invention;

FIG. 5 illustrates a cache of recently visited procedures in accordance with the present invention;

FIG. 6 shows code used in an example of a flowchart editor in accordance with the present invention;

FIG. 7 shows a flow chart used in a flowchart editor in accordance with the present invention;

FIG. 8 illustrates an example of a tree of flowchart objects which wrap and extend Design-coderepresentations in accordance with the present invention;

FIG. 9 illustrates an example of wrapper objects and Design-CodeRepresentation objects working together;

FIG. 10 shows an example of generated code;

FIG. 11 shows the flowchart which describes the code of FIG. 10;

FIG. 12 shows an amendment to the flowchart of FIG. 11;

FIG. 13 shows an amendment to the flowchart of FIG. 11;

FIG. 14 shows an amendment to the flowchart of FIG. 11;

FIG. 15 shows an amendment to the flowchart of FIG. 11;

FIG. 16 illustrates a sample of pseudo language description of a car data structure and corresponding data diagram;

FIG. 17 illustrates a possible runtime view of a data structure wherein values are recorded and displayed for data fields within the car data structure;

FIG. 18 illustrates an example of a first-pass matching technique;

FIG. 19 illustrates an example of parsing Design-CodeRepresentation structure from code;

FIG. 20 illustrates an example of Design-coderepresentations being created through changes in design views; and

FIG. 21 illustrates an example of a Design-CodeRepresentation objects hold both code-specific and design-specific data.

FIG. 22 is a block diagram which shows the result of conducting a parse in accordance with the present invention on a piece of code;

FIG. 23 shows examples of a parse in accordance with the present invention, including merging of code and comment data into Design-CodeRepresentation objects;

FIG. 24 is a table which shows the Design-CodeRepresentation structure after parsing of first line.

FIG. 25 is a table which shows the Design-CodeRepresentation structure after parsing of second line;

FIG. 26 is a block diagram which shows the Design-CodeRepresentation structure after parsing of Line 4;

FIG. 27 is a block diagram which shows the Design-CodeRepresentation structure after parsing of Line 5.

### DETAILED DESCRIPTION OF THE DRAWINGS

The present invention provides for the creation of a software development tool wherein program code and detailed design information are synchronised either automatically or on command by the user. Synchronisation requires monitoring changes in either or code or design side components and conveying these changes amongst components so they can be updated to reflect the latest known state of either the code or design.

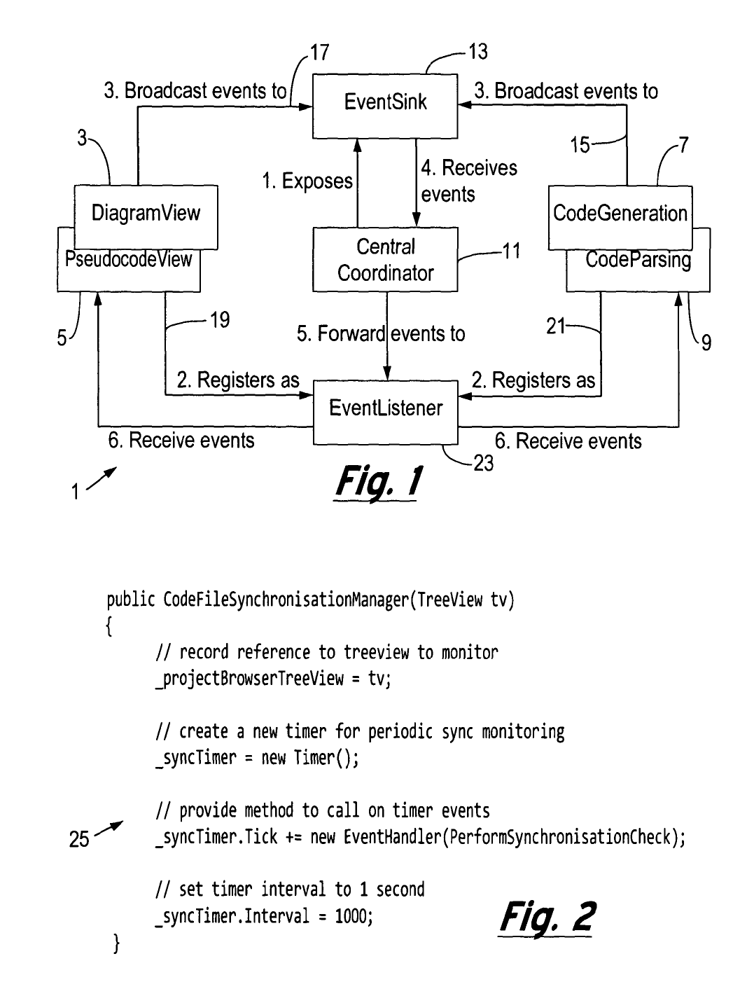

FIG. 1 shows an example of a system architecture which implements the present invention. A number of design-side components may exist, such as a diagrammatic view 3 of the detailed design for program code, a pseudocode/textual view 5 of the detailed design of program code. A number of code-side components may exist such as code-generation components 7, code-parsing 9 components, components that integrate with software development environments. A central coordinating component 11 is responsible for instantiating the code-side and design-side components and provides them with ‘interfaces’ through which they can communicate to both send and receive events of interest, e.g. notifying of changes to existing code or design elements, notifying when code or design information is being loaded or saved, notifying when code or design elements are created or deleted.

As shown in FIG. 1, the Central Coordinator 11 exposes itself as an EventSink 13, i.e. a location to which design-side and code-side components can broadcast event notifications 17, 15 respectively. Each design-side and code-side component registers itself 19, 21 respectively as a form of EventListener 23, i.e. something which is interested in being notified of events as they occur. When something of interest occurs in one of the design-side or code-side components, such as a change to a design element or the creation of a new design element, an event will broadcast 15, 17 to the EventSink 13 so that all of the other design-side 3, 5 and code-side 7, 9 components can be notified of the change and can respond accordingly, e.g. by updating their displays.

The Central Coordinator 11, which acts as the EventSink 13, will receive the events as they arise and will forward any event it receives to a list of EventListeners that it maintains—ensuring that the event doesn't get broadcast to the component that the event originated from in the first place. Each design-side 3, 5 and code-side 7, 9 component registered as an EventListener shall receive the event.

Synchronisation may be performed using both a ‘live’ approach at a procedural level in the code and a ‘merged’ approach at both a procedural level and file-based level. These two approaches are described below.

In the following example, live or real-time sychronisation is performed at the level of ‘procedures’ in the code, or what also may be termed functions, methods or routines. For example, the following is an example of a code procedure which adds two numbers together and returns the result.

int Add(int x, int y)
{
return x + y;
}

It is the internal details of procedures 25, i.e. the algorithmic steps they perform, which is the focus of synchronization as is further illustrated in FIG. 2.

In this example of the present invention, live synchronization occurs in the following ways:
1. Detecting changes in program code and updating design views as necessary: Code-to-Design Method.
2. Detecting changes to design documentation and updating the program code. Design-to-Code Method

### Code-To-Design Method

The Code-To-Design method requires monitoring changes to program code. Program code is typically developed using an Integrated Development Environment (IDE) such as Microsoft Visual Studio or Eclipse or simpler text editor programs such as Notepad.

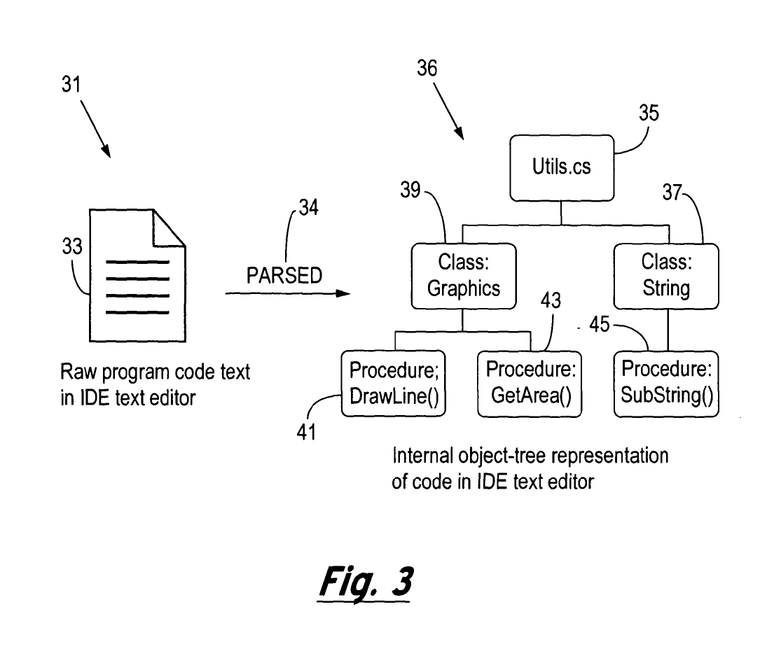

More sophisticated IDEs (such as Visual Studio and Eclipse) provide what is known as an Application Programming Interface (API) which provides a set of functions to allow third-party software components to access and manipulate the contents of the IDE. Programmatic access of program code in an IDE can be achieved through: (i) direct manipulation of the text in the IDE text editor; or (ii) through manipulation of an object tree held within the IDE which represents the program code structures currently displayed within the IDE's text editor. For example, in Visual Studio this object tree is often referred to as the FileCodeModel or as Abstract Syntax Tree (AST) in Eclipse. FIG. 3 is a graphical representation of such an object tree showing parsing 34 of raw program code text 33 to an internal object tree structure 36. Each node in the tree will typically identify the type of code element it represents (e.g. a Class 37, 39, a Procedure 41, 43, 45, an Attribute 35) and will contain information such as the code for the element as well as its placement within the corresponding program code file, e.g. the element starts at line 20 and ends on line 38 in the program text.

The Code-To-Design method of synchronization uses two methods to detect changes to code to allow subsequent synchronization with design views. These are: (i) IDE-Integrated method and (ii) a File-Monitoring method.

The IDE-Integrated Method of Synchronisation uses the API of an IDE to obtain live access to code as it is being edited by a software developer and to detect pertinent events indicating changes to code and/or changes in editing locations/position. Synchronisation is performed at the procedural level as described previously and requires the following steps:

Confirm the user is currently in a valid program code file within the IDE. This is typically performed through the IDE's API by either checking whether a FileCodeModel (or AST if Eclipse) currently exists OR by determining the path of the currently opened file in the IDE and making an assumption about is status based on its file suffix, e.g. a suffix of ‘.cs’ typically suggests a program code file for the C# (pronounced C-Sharp) programming language.

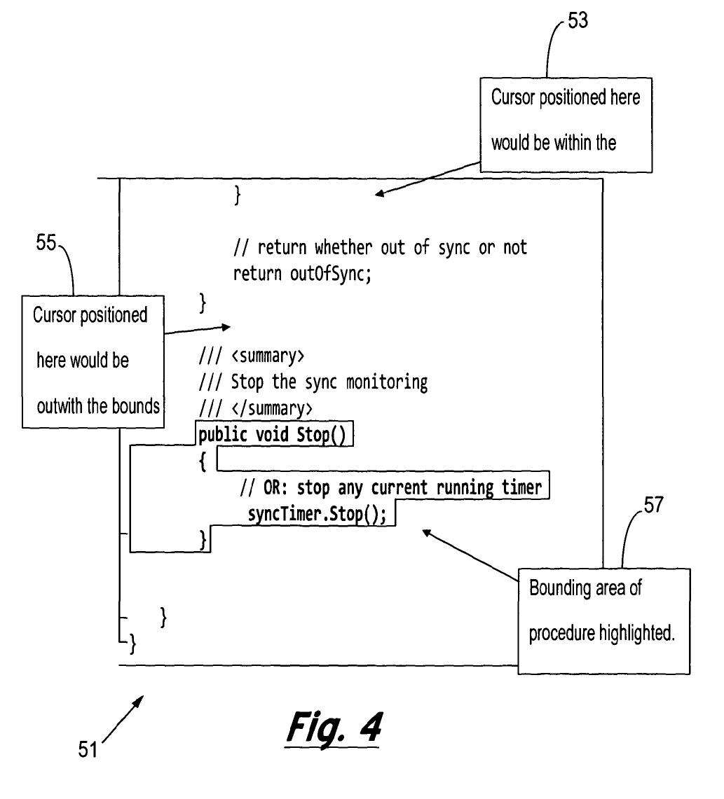

Confirm that the user is currently placed within the bounds of a procedure in the program code file being edited as is illustrated in FIG. 4. This is achieved by determining the position of the text editing cursor/caret within the code file and then determining whether it falls within the known start and end lines and character positions occupied by a procedure in the code. For example a cursor at position 53 would be within the bounds, a cursor at position 55 would be beyond the bounds; the bounded area being highlighted 57. This can typically be achieved by utilizing the IDE's API to obtain positional information. Otherwise positional information will be manually derived requiring a parse of the entire code content of the currently selected file within the IDE to note the type of program code structures encountered and their positions within the program code text in terms of line numbers and optionally column numbers.

Having determined that the user is currently positioned within the bounds of a procedure within the program code being edited, the actual code for this procedure may be retrieved. This can be achieved using the IDE's API to directly request the corresponding code. Alternatively conducting a manual extraction as described above from the appropriate positions from the parsed content of a program code file.

Having retrieved the code for the procedure which is currently being edited within the IDE it shall be determined whether this code has changed since the last time it was inspected. This is achieved by utilizing a two-stage cache of recently visited procedures. The purpose of the two-stage approach is to avoid unnecessary parsing of code which may not have changed since the last time it was viewed and which has resultant benefits in preserving changes in design views which have not yet been committed to code.

A primary cache holds an in-memory copy of the code content for any current in-edit procedure during editing tasks. If a procedure has been selected for the first time, this cache will initially be empty. Otherwise it will contain the previously known state, in terms of program code, of the current in-edit procedure. If it is detected that the actual code corresponding to the current in-edit procedure has or is about to be changed (for example by receiving notification of a text changed event via the IDE's API) the newly edited code for the procedure will be retrieved BUT will not yet replace the content of the aforementioned cache. Rather, both the old and new versions of code for the current in-edit procedure will be allowed to temporarily co-exist to facilitate subsequent consultation with a secondary cache of information.

A secondary cache is utilized which contains the previously known state, in terms of program code, for ALL procedures recently visited by the user during their current editing session along with a corresponding Design-CodeRepresentation object/data structure. FIG. 5 shows a representation of a secondary cache 61. The secondary cache 61 contains a set of matched-pairs 63, 65, 67 comprising the code for the respective procedure 64, 66, 68 and a corresponding Design-CodeRepresentation 72, 74, 76. The Design-CodeRepresentation structure is a bringing together of both code-specific and design-specific information pertaining to any program code procedure and is the primary source of consultation for both code-side and design-side components during synchronization tasks. The purpose of the secondary cache is to prevent unnecessary re-parsing of code and unnecessary re-generation of corresponding Design-CodeRepresentations in the event that the contents of the code may not have changed since the last time they were inspected.

The secondary cache is used thus. The previous state, in terms of program code, of the current in-edit procedure is currently held within a primary cache. If the current in-edit procedure has been selected for the first time by the user, its previous state will be unknown, i.e. the primary cache will be empty. Otherwise, the cache will contain the previous state and it is possible that, through impending edits, a new future state of the current in-edit procedure is also known. Having reached this point a search will be conducted on the secondary cache to determine if it contains an element matching the previously known state of the code for the current in-edit procedure (as per the contents of the primary cache). This may produce several outcomes.

If no matching element is found on the secondary cache whose code matches the previously known state of the current in-edit procedure this signals that the current in-edit procedure hasn't previously been visited by the user during their current code editing sessions. In which case the newest known state of the code for the current in-edit procedure will be parsed to produce a corresponding tree of Design-CodeRepresentation objects and will subsequently be passed to design views to process.

Both the latest known code for the current in-edit procedure and its corresponding Design-CodeRepresentation object tree will be placed on the secondary cache as a matching pair to assist the processing of future visits and/or edits to the same procedure. The primary cache will be updated to contain the newest known state of the current in-edit procedure.

If an element is found on the secondary cache whose code matches the previously known state of the current in-edit procedure BUT it is known that the actual code for this procedure hasn't been or isn't about to be changed (i.e. there are no impending edits) this signals that the cached version of the procedure is up to date. In this case no fresh parse of the code is required to be able to produce a corresponding Design-CodeRepresentation object tree for subsequent passing to design views. Instead the most recently known version of the Design-CodeRepresentation object tree which corresponds to the procedure can be obtained from the secondary cache, from where it was placed during a previous parse of the procedure's code, and passed onto the design views for display. Neither of the primary or secondary caches need be updated.

If an element is found on the secondary cache whose code matches the previously known state of the current in-edit procedure AND it is known that the actual code for this procedure has now changed, the following steps will take place: (i) the newly updated code for the procedure will be parsed to produce a new tree of corresponding Design-CodeRepresentation objects which will subsequently be passed to design views to present; (ii) the newest state of the program code for the current in-edit procedure and the newly created Design-CodeRepresentation object tree will be placed on the secondary cache as a matching pair, replacing those which were previously on the cache for the same procedure; (iii) the newest state of the program code for the current in-edit procedure will be placed on the primary cache.

The above method of synchronization adopts a write-replace strategy. When changes are detected in the program code for a procedure, a completely fresh parse of the code is undertaken which produces a completely fresh set of information for passing to design views (a new Design-CodeRepresentation). This fresh information will overwrite any information which was previously in place. This is in contrast to a merge strategy which may attempt to retain the original information but introduce only the changed aspects, rather than attempt to completely overwrite it.

The File-Monitoring Method of Synchronisation monitors the last modified date and time of files at known locations on a computer, or possibly remote locations, which are known to contain program code.

The user can specify the program code files which they wish to monitor by specifying their location on disk and/or dragging and dropping them onto an application which can then automatically deduce their location. It is also possible to specify a containing folder to monitor in which case changes to the entire contents of folder will be monitored, e.g. adding or deleting files, renaming files, modifying the contents of files, addition of sub-folders and subsequent modifications to their contents.

When a program code file is specified for the first time an initial parse of its code content will take place to create an initial timestamp of both the file content and the current last-modified date and time of the associated file. The parse will produce a resultant Design-CodeRepresentation object tree. The resultant design information can be provided to design components for processing.

Having specified the program code files of interest, these will be monitored for possible changes. A containing application will encapsulate the change detection logic. A dedicated application is provided which may be manually invoked by the user and allows them to open a design ‘project’ which contains links to the files in question being monitored, and will subsequently automatically monitor these files for changes.

Alternatively a Windows service type application is provided which is automatically launched when Windows starts-up and runs as a background task which constantly monitors known files and locations for changes and can automatically process the changes as described below or provide notifications to the user to allow them to choose what actions to take and when.

Changes to files and folder locations are detected by implementing either a timer which constantly polls the timestamps (last date/time modified) of known files and locations and comparing them to previously known timestamps OR by adopting an event listener which can listen for file related events as and when they occur—as provided by the FileSystemWatcher component as part of the Microsoft .NET framework.

The files in question are typically changed by someone opening them in a code editor of choice (e.g. Eclipse, Visual Studio, Notepad), making changes and saving them, at which point the timestamp on the file will be modified.

If a file is detected as having changed because its timestamp is different than that previously recorded for the same file the following steps will take place: (i) the content of the file will be re-parsed and a resultant set of Design-CodeRepresentation objects produced and which will replace/overwrite any previous set of Design-CodeRepresentation objects for the same file content OR a merge approach will be adopted to merge new content with older content; (ii) the new timestamp of the file will be recorded to enable continued processing to detect future changes.

The user has the ability to save the content of the Design-CodeRepresentation content for the program code files being monitored to a file on disk, and which can subsequently be opened and loaded at a later if desired. This requires saving, for each Design-CodeRepresentation object, its object type, and all other information pertinent to both code-side and design-side components, e.g. program code, descriptive text for design views and associated attributes.

The Design-To-Code method of synchronisation requires monitoring and detecting changes within any one of a number of design-side components and ensuring these changes are then conveyed to the corresponding code-side components and to other design-code components within which the change did not originate.

The following design-side components are provided:
1. A Pseudocode Editor which provides a means of viewing and editing a pseudocode representation for procedural-level program code.
2. A Flowchart Editor which provides a means of viewing and editing a diagrammatical representation of procedural-level program code in the form of a structured flowchart'.
3. A State Diagram Editor which provides a means of viewing and editing a diagrammatical representation of procedural-level program code in the form of a state transition diagram.
4. A Data Diagram Editor which provides a means of viewing and editing both textual and diagrammatical representations of data structures used within program code in various forms.

The system architecture facilitates communication between design-side and code-side components, which includes the possibility of one design-side component communicating with other design-side components and similarly for code-side components. Each component acts on its own accord and conveys information to ALL other components whether they be code-side or design-side. The communication is facilitated by the EventSink and EventListener mechanisms as previously described which route event notifications between components. It is then up to the individual components to decide what to do when they receive any event. They may choose to ignore it, to respond to it immediately OR to keep a record of the information and to respond to it at a later time.

The sorts of events that are conveyed between components range from the minutiae to the coarse-grained, for example simple text modifications (such as renaming); changing of an element's type (e.g. from an Assignment statement to an ‘if’ statement); the creation of a new element; the deletion of an existing element; copying and pasting elements (which may result in a batch of new element creation events to represent the pasted content). Each of these events will be detected by the design-side components as and when they occur and will subsequently be dispatched for notification to all other components using the EvenkSink mentioned previously.

A description of each design-side component is provided below. This is followed by further information regarding communication and synchronisation between the system components.

The Flowchart Editor provides a means of creating and editing a diagrammatical representation for a program code procedure. This requires drawing symbolic representations for program code constructs (such as ‘for’ statements, ‘while’ statements, ‘if’ statements, etc.) and ensuring they are displayed in relation to each other in a manner which reflects their position and sequence with the corresponding program code and also ensuring they are conveyed in a ‘pleasing’ format, e.g. no overlapping of lines for connected elements, elements with ‘branching’ qualities are positioned so as to ensure their child/containing elements have enough space without overlapping other content in the diagram.

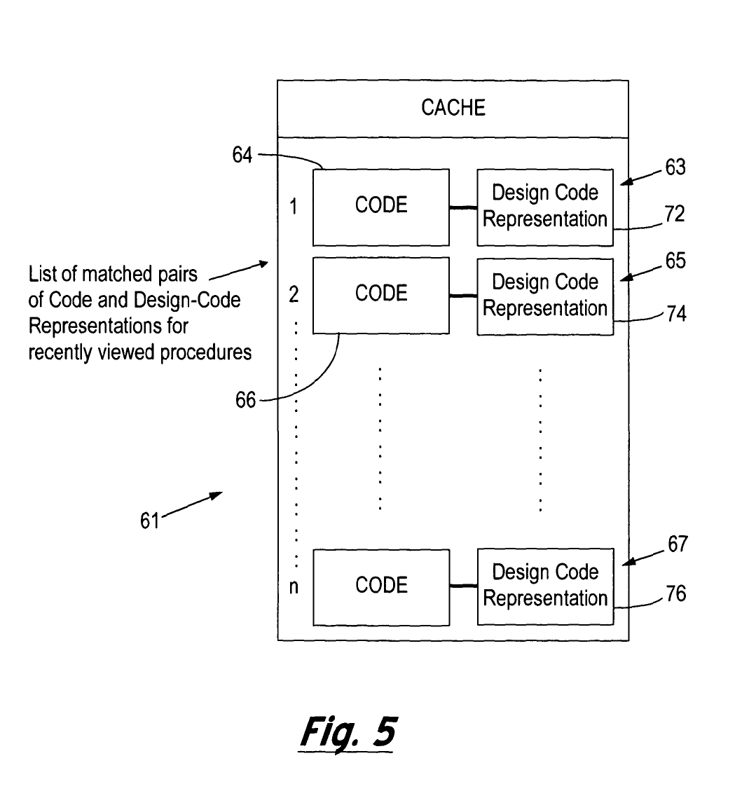

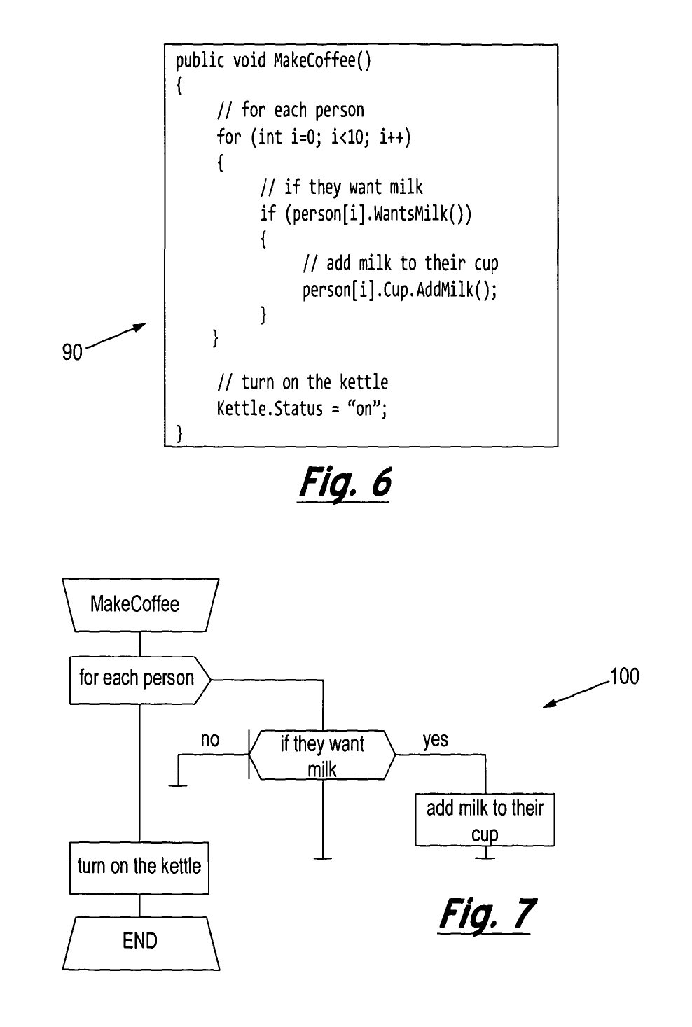

As shown in the piece of code shown in FIG. 6 symbols are used to denote the various code constructs and the layout which ensures correct placement and sequencing and the prevention of overlap. Also of note are those code elements which use ‘branching’ as a means of enclosing their content. For example, the ‘for’ loop (for each person) has branched all of its content to the right-hand side of the main central flow of the diagram; the ‘if’ statement (if they want milk) has branched its content to both the left and right-hand sides of itself with the left side representing steps which will be undertaken if the condition in the ‘if’ statement evaluates to FALSE (e.g. they don't want milk) and the right side representing steps to undertake if the condition evaluates to TRUE (they do want milk).

The flowchart of FIG. 7 is a design side representation of the code of FIG. 6. Other code-side or design-side components will inform the flowchart editor when a procedure has been selected (for example if the user has clicked on a procedure in the text editor of an IDE). The flowchart editor will also be informed when a procedure is subsequently de-selected, at which point it will clear its display to prevent display and editing of flowcharts. The selection and de-selection notifications (and any other events) will be sent to the flowchart editor through the EventSink-EventListener mechanism described previously.

The component which informs the flowchart editor of the procedure selection will also provide the flowchart editor with the Design-CodeRepresentation object tree which corresponds to the procedure. For example, if the user has clicked on a procedure within a program code file in an IDE, the code-side component which monitors the IDE will retrieve the procedure's code and may utilize the parse to produce the corresponding Design-CodeRepresentation tree.

The flowchart editor will use the Design-CodeRepresentation tree for the procedure as the primary source of information regarding how to construct and display a flowchart to represent the procedure diagrammatically.

The flowchart editor will extract all relevant information it requires about each Design-CodeRepresentation object, those of primary interest being the following: (i) the ‘Type’ of object (whether it's an ‘if’ statement, a ‘for’ statement) which will allow the flowchart editor to determine the type of symbol to use to represent the object and also to make decisions regarding whether any ‘child’ elements will be branched to the left and/or right; (ii) the object's ‘Text’ property which provides the natural language description of the intent of the code represented by the Design-CodeRepresentation object and which the flowchart will draw/display inside the symbol drawn for the object.

In certain cases the flowchart editor may also consult the ‘Code’ property of the Design-CodeRepresentation object should the user wish to view the actual program code within the flowchart representation rather than or along with its natural language description.

The flowchart editor will derive the core information required to generate a flowchart representation from the Design-CodeRepresentation object tree. However, the flowchart editor will also augment the core information for any Design-CodeRepresentation object with additional flowchart specific properties and functionality. The key flowchart specific information which augments the data for any Design-CodeRepresentation object is related to drawing logic, i.e. storing the position and size on screen where the symbol that represents the Design-CodeRepresentation is displayed. This information is necessary to allow subsequent ‘hit-testing’ of the element amongst other tasks, i.e. to deduce when the user has clicked the mouse while positioned over the element.

There is also a range of functionality associated with such information required to query and perform hit-testing and other display related tasks. This additional data and functionality related to each Design-CodeRepresentation object needs to be held internally within the flowchart editor. The method adopted for this is to create a set of ‘wrapping’ objects which contain references to the core Design-CodeRepresentation structure but which then augment or ‘wrap’ that core data with additional flowchart specific data and functionality.

The general idea behind the wrappers is to ensure that any code-side or design-side component doesn't ‘pollute’ the purity of a Design-CodeRepresentation by inserting component-specific content into it in such a way that it would require any of the other code or design-side components to be aware of it. Otherwise this would create a stronger form of ‘coupling’ between different components needing to know about each other's data, when they should in fact be able to manage their own data privately themselves.

Components will often record temporary information which is used during processing which relates to the associated Design-CodeRepresentation they are working with. Rather than trying to record such temporary data within the Design-CodeRepresentation itself (which is intended to persist beyond the temporary manipulations of the component) it makes more sense to keep the temporary data separate but linked to the Design-CodeRepresentation it relates to. The wrapper elements allows temporary, component-specific content to be wrapped around an associated Design-CodeRepresentation.

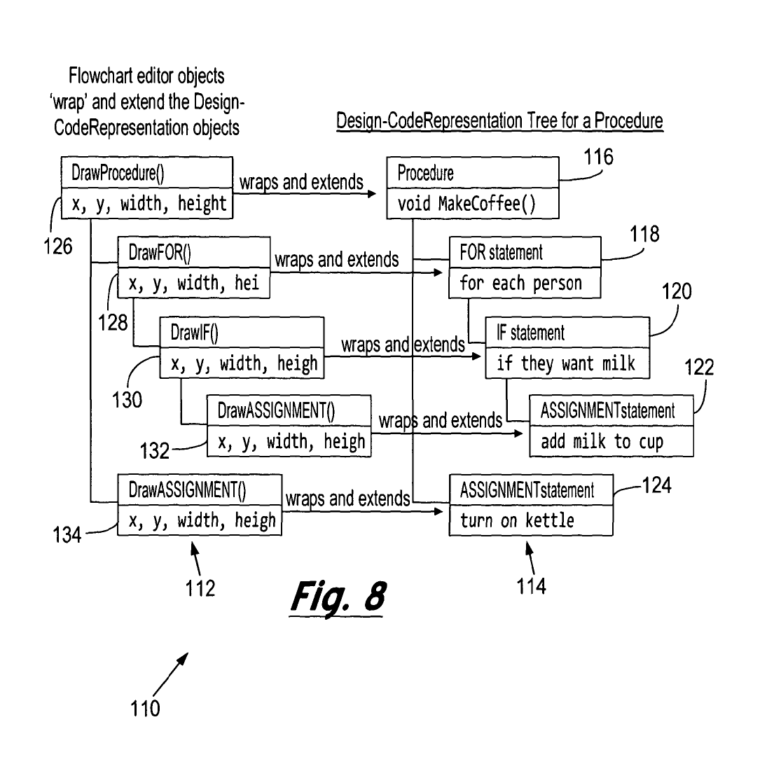

FIG. 8 is a block diagram 110 which shows a series of flow chart editor objects 112 and a design code representations tree 114. When the flowchart editor receives a procedure selection notification which includes the actual Design-CodeRepresentation for that procedure it will create its own wrapper objects around it. This requires traversing the entire tree of Design-CodeRepresentation objects 116, 118, 120, 122, 124, creating a corresponding flowchart editor wrapper object for it 126, 128, 130, 132, 134 which includes a link reference to the Design-CodeRepresentation it relates to and placing each wrapper object within a tree structure which mimics the structure of the Design-CodeRepresentation tree.

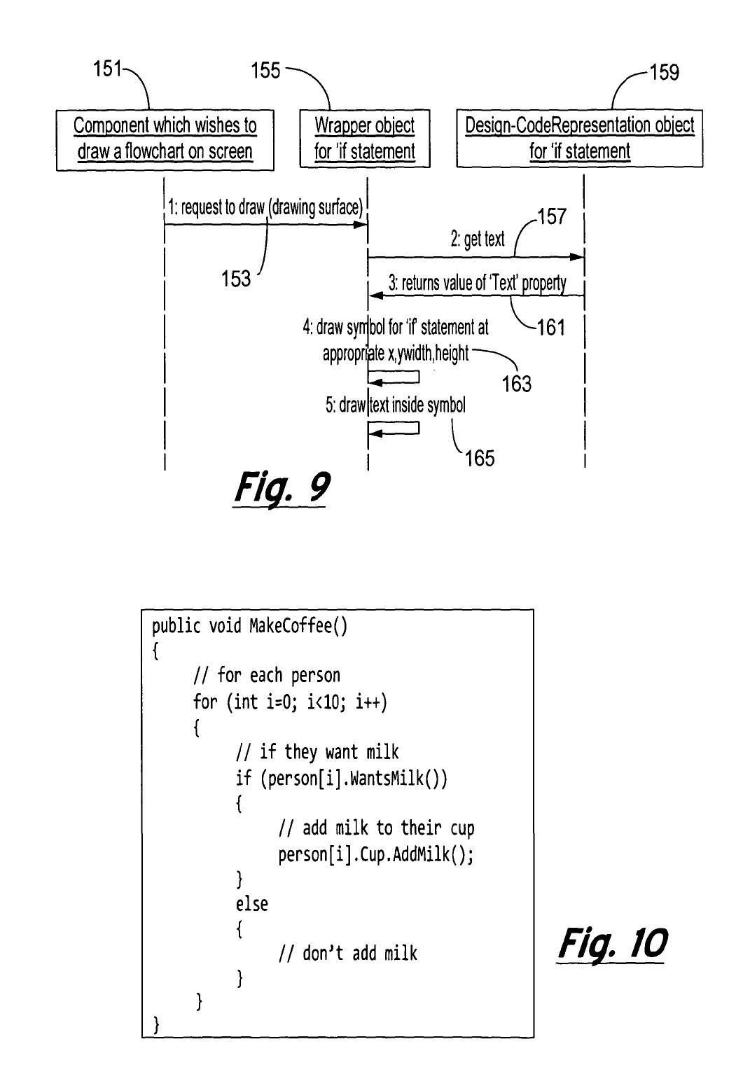

Subsequently, during processing, the flowchart editor uses its tree of wrapper objects as the primary source of consultation when querying and manipulating information for the Design-CodeRepresentation objects. For example, if we wished to query the ‘Text’ property for an ‘if’ statement which was about to be displayed on screen it may occur as shown in FIG. 9. NOTE: bear in mind that the ‘Text’ property is something which is recorded as part of a Design-CodeRepresentation object. Therefore, if we request this information from one of the flowchart editor wrapper objects the wrapper object needs to forward/delegate that request onto the corresponding Design-CodeRepresentation object that it is linked to.

FIG. 9 shows a component 151 that wishes to draw a flowchart on screen issuing a request to a flowchart editor wrapper object 155 to draw itself, and passing along the ‘surface’ to be drawn upon. The flowchart editor wrapper object needs to retrieve 157 the ‘Text’ information to be displayed. This is information which is contained within the Design-CodeRepresentation object 159 which is linked to the wrapper object, therefore a request is issued to the Design-CodeRepresentation object to retrieve the value 161 of its ‘Text’ property. The flowchart editor wrapper object subsequently draws the symbolic representation required on screen 163 (in this case for an ‘if’ statement) and displays the text within it 165. This represents the general strategy adopted when querying and modifying the contents of a program code procedure as represented in Design-CodeRepresentation form.

A code-side or design-side component can store private information inside a Design-CodeRepresentation object should it wish to. However, this is achieved in a flexible way which doesn't compromise the coupling between components, i.e. components are not made visible to or dependent upon the specific data of other components unless they choose to be (to support transferral of information between them for example). Each Design-CodeRepresentation structure incorporates unrestricted storage for what are termed ‘extensible values’ which can be populated with the data from any component. Such data is subsequently viable for storage to disk alongside standard Design-CodeRepresentation data fields. Such data can then subsequently be loaded from disk as part of a Design-CodeRepresentation structure and retrieved by the component(s) which placed it there initially

The flowchart editor automatically draws and formats diagrams for the user, to spare them the expense of drawing boxes and lines and connecting them manually. This requires the flowchart editor to adopt drawing logic which ensures the diagram symbols are displayed correctly and to ensure they are laid out in a pleasing manner which prevents overlap and crisscrossing of lines.

When a flowchart is being displayed different code constructs have different symbols to represent them, e.g. assignment statements may have a rectangular box, an ‘if’ statement may have a rectangular box but with arrowed heads to either side which may indicate branching to the left or right of the content of the ‘if’ statement. The key challenges in drawing are ensuring the symbols are presented in the correct order, ensuring the flow of information is correct, and ensuring each code construct is drawn so as to have enough separating space between itself and other elements (e.g. no overlaps) and there are no overlapping or crisscrossing of lines which join elements together.

The position and flow of the content is addressed as a natural consequence of the order/hierarchy in which the code constructs are presented in the first place—in the form of a Design-CodeRepresentation tree. This tree already ensures that code constructs have been arranged in the order in which they occur within the program code and also ensures that parental relationships between objects have been maintained (e.g. an ‘if’ statement which may contain several assignments and another ‘if’ statement as children within it). In order to draw these objects on screen, the task then is just to traverse them in the order in which they appear. However, due to the challenges of ensuring that elements do not crisscross or overlap the traversal is typically performed using a recursive back-tracking approach.

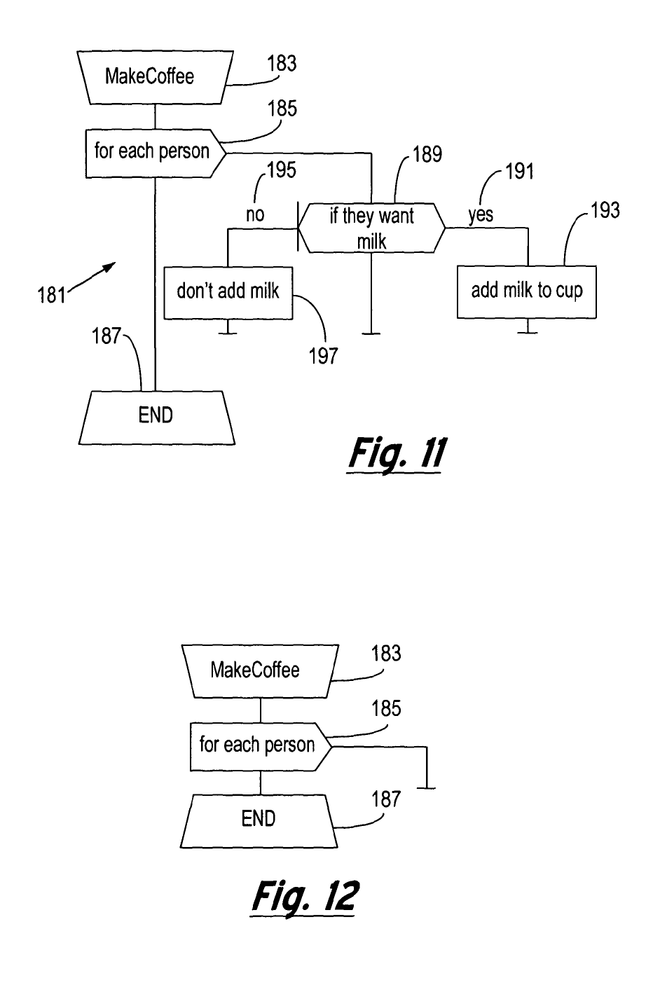

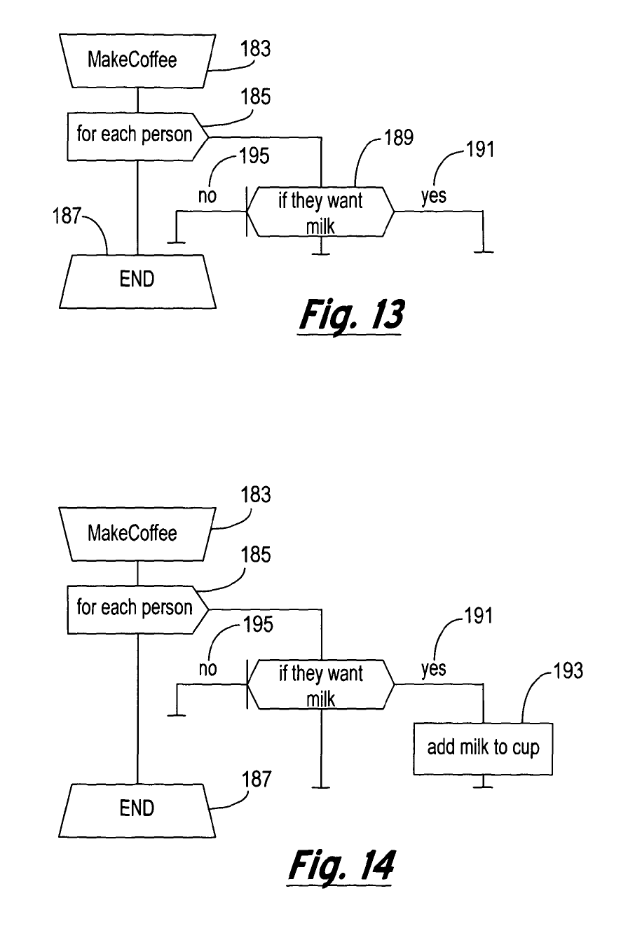

The code shown in FIG. 10 would result in the creation of the flowchart 181 of FIG. 11. FIGS. 12 to 15 show how the drawn flowchart changes depending upon the code that is input by the user if this flowchart was drawn as a straight start to end traversal of the contents of the Design-CodeRepresentation structure.

A ‘for’ statement 185 is encountered. This would be drawn centrally within the main flow line in the procedure as shown in FIG. 12:

An ‘if’ statement 189 would be encountered as a child of the ‘for’ statement. The ‘if’ will be drawn centrally within the main flow line of the ‘for’ statement's ‘child’ area (branched to the right side of the ‘for’ statement). The ‘if’ statement will be positioned thus: (i) calculate the width of horizontal area required to display the ‘if’ statement including any branch lines from its left and right sides; (ii) calculate the position of the left-most side of the ‘if’ statement to be the horizontal mid-point occupied by its ‘parent’ element (the ‘for’ statement) plus enough horizontal space to the right to leave a comfortable horizontal gap between them; (iii) draw the branch line from the parent element to connect to the ‘if’ statement at the following point: the left-most position of the ‘if’ statement+(the horizontal width of the ‘if’ statement divided by 2); (iv) draw the ‘if’ statement from its left-most position. NOTE: pre-defined margins are used to indicate the level of spacing desirable between elements vertically and horizontally. This would produce the flowchart shown in FIG. 13:

An assignment statement will be encountered as a child of the ‘if’ statement to perform when the condition ‘if they want milk’ evaluates to TRUE. This assignment is ‘add milk to cup’ 193. This can be drawn in much the same way as the ‘if’ statement was drawn as per step (2) above: (i) calculate the width of horizontal area required to display the assignment statement; (ii) calculate the position of the left-most side of the assignment statement to be the horizontal mid-point occupied by its ‘parent’ element (the ‘if’ statement) plus enough horizontal space to the right to leave a comfortable horizontal gap between them; (iii) draw the branch line from the parent element (the ‘if’ statement) to connect to the assignment statement at the following point: the left-most position of the assignment statement+(the horizontal width of the assignment statement divided by 2); (iv) draw the assignment statement from its left-most position. This should result in the following:

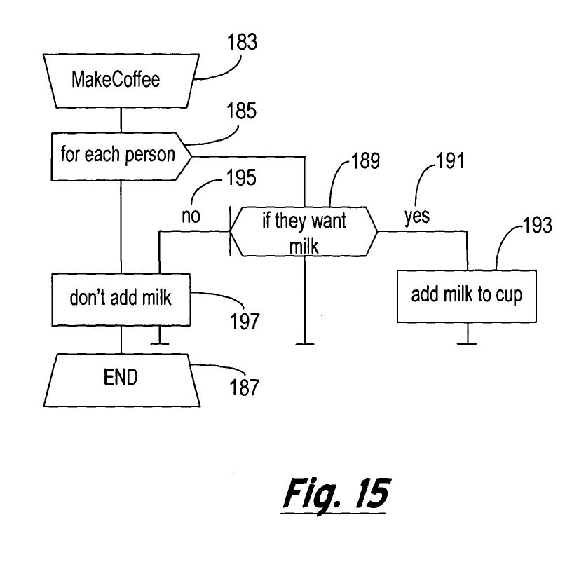

An assignment statement will be encountered as a child of the ‘if’ statement as part of its ‘else’ clause, as an action to perform when the condition ‘if they want milk’ evaluates to FALSE. This assignment is ‘don't add milk’ 197. Typically, this content will be displayed on the left-side branch of an ‘if’ statement rather than the right-side branch. The default strategy for drawing the content could be to follow much the same steps as required to display the assignment statement in step (3) above but applied to the left side of the ‘if’ rather than the right side. However, as will be evidenced later, this may pose problems. We may attempt to draw the assignment thus: (i) calculate the width of horizontal area required to display the assignment statement; (ii) calculate the position of the left-most side of the assignment statement to be the horizontal mid-point occupied by its ‘parent’ element (the ‘if’ statement) minus enough horizontal space to the left to leave a comfortable horizontal gap between them and minus the horizontal width of the assignment statement; (iii) draw the branch line from the parent element (‘if they want milk’) to connect to the assignment statement at the following point: the left-most position of the assignment statement+(the horizontal width of the assignment statement divided by 2); (iv) draw the assignment statement from its left-most position. As shown in FIG. 15.

As can be seen, the simple drawing logic has been highly successful up until the last case where a newly added assignment statement (‘don't add milk’) is drawn such that it overlaps/encroaches into the area occupied by another element on the flowchart. The problem is, we have been careful to ensure this assignment statement didn't encroach over the mid-point occupied by its parent element (‘if they want milk’) but without realizing that, in the process, we have encroached upon the mid-point occupied by the grandparent element (‘for each person’) instead. This is a general issue with elements in which branching horizontally is required. The novel solution adopted is to a reverse traversal of the child elements in branched statements so that the true extent of area occupied by the child elements can be determined first using default locational information, and then the parent items can re-align their own positions to determine whether they need to shift their mid-points further to the left or right to prevent the child elements from encroaching over the areas occupied by their grandparents.

For example, the assignment statement ‘don't add milk’ will be drawn in its default position using a suggested midpoint (provided by its parent) which may result in the overlap over the grandparent midpoint as illustrated above. However, now that the child element has been processed, the flow of control will move back up to the parent element (‘if they want milk’) which also attempts to draw itself using the midpoint information it provided to the child element. The parent element will check the extent of area occupied by its child elements and will ensure that they don't encroach on its own midpoint area. If they do it will attempt to shift the midpoints of the child elements by pushing them further to the left or right to resolve the encroachment.

Now that the parent element has been processed the flow of control will pass up towards the grandparent element (‘for each person’). This element will attempt to draw itself based upon the (suggested) midpoint of its child element (‘if they want milk’). In doing so, it will check that extent of area occupied by its child element. The child element will return the area occupied by itself and all of its child elements (e.g. ‘don't add milk’). The grandparent will realize that the left-most extent of the area occupied by its child or grandchildren is encroaching over its midpoint area. Therefore the grandparent will provide a revised midpoint to its child element which will force the child to move itself (and all of its child elements) further to the right of the diagram to prevent the encroachment. This strategy will filter upwards through the rest of the hierarchy until we reach the top.

Once all of locations for the various diagrammatic representations have been calculated, which may include shifting of content to the left and right as described above to prevent encroachment, the diagram itself can then be displayed by actually drawing the symbols at these locations and the connecting lines between.

Importantly, simplicity in the drawing logic is achieved by adopting a ‘redraw-everything’ approach to processing changes to procedural-level code. For example, if a new code construct has been added into the program code for a procedure (e.g. a new ‘if’ statement is added) rather than attempting to locate the specific position at which the new ‘if’ statement should be drawn in the existing flowchart, and then considering how this will affect any surrounding elements that it will be joined up and which may need to be shifted (to prevent any criss-crossing of lines or overall) which in turn may cause any adjoining elements for these surrounding elements to be adjusted too, and so on. Rather that attempt the preceding, the approach taken is simply redraw the flowchart in its entirety which will automatically result in the new changes being incorporated. So, for each change notification received by the flowchart editor (through the EventSink-EventListener mechanism) the default response is simply to redraw the entire chart to display the latest known state of the procedure—and which may result in the addition or removal of corresponding flowchart editor wrapper objects depending on the nature of the change which has taken place. Presently this approach does not result in performance issues.

The flowchart editor provides a mechanism for the user to visually edit the contents of a procedure. This includes moving of code constructs around the flowchart (e.g. dragging an ‘if’ statement currently positioned at the end of a flowchart and dropping it somewhere else); clicking on elements in the flowchart to select one or more of them which can subsequently be deleted, copied or refactored into a completely new procedure, and dragging and dropping of new elements into the flowchart using a toolbox of available code constructs (e.g. drag and drop a new ‘for’ statement into the flowchart). The user may also edit the properties for any Design-CodeRepresentaion object such as changing its Text or even its Code property and other status attributes as may be provided.

The general strategy for notifying other components of edits which take place within the flowchart editor (or indeed any of the other code-side or design-side components) is to:

detect the change;
apply the change directly to the contents of the Design-CodeRepresentation structure corresponding to the current in-edit code-design information;
broadcast one or more events through EventSink to other components to inform them what has taken place, typically forwarding references to the specific Design-CodeRepresentation object(s) affected by the edit along with an indication of the modification (e.g. a deletion, a creation, a modification) and positional information (e.g. where the items are positioned within a Design-CodeRepresentation tree structure);
redraw the flowchart to display any changes which have taken place.

The strategy for receiving notifications of edits which may have taken place within other code-side or design-side components is:

receive an event from the EventListener structure;
determine the type of event and action required, e.g. a text modification, a new element created;
retrieve references to the Design-CodeRepresentation structures affected by the edit, as provided by the event notification;
examine those Design-CodeRepresentation structures to obtain their changes;
if required create or remove ‘wrapper’ objects to wrap content around the Design-CodeRepresentation objects affected;
redraw the flowchart to display the changes.

Design-CodeRepresentation objects have data fields which record whether they have any program code associated with them or not, and whether they represent a construct which may be semantically misplaced (e.g. an ‘else’ statement inside a ‘for’ loop). The fields of any Design-CodeRepresentation object can be queried to check its status and which subsequently allows any code-side or design-side component to convey this information in appropriate ways. For example, the diagram can highlight, using symbols, colours and/or adornments, the progress of/existence of code content, the semantic status of the element, etc.

Design-CodeRepresentation objects also have data fields which record information pertinent to the development of a software system, e.g. project management information (progress stats, usage stats, versioning information, resource information, review status), testing information (which parts of code have been tested or not), and so on. This information can be queried by any code-side or design-side component to convey this information in appropriate ways. For example, the flowchart editor can highlight, using symbols, colours and/or adornments, the test status or review status for particular sections code-design content.

The Pseudocode Editor provides a means of creating and editing a pseudocode representation for a program code procedure. Pseudocode is a commonly utilized programming design technique which allows a software developer to create and explore a natural language/plain English representation for any program code algorithms they wish to comprehend and implement. Pseudocode expresses the complexity of the program code instructions at a higher level of abstraction but will typically utilize certain programming keywords to provide structure to the information. For example, keywords such as ‘if’, ‘while’. The following example provides an extract of pseudocode for the algorithm/process required to make a cup of coffee:

```
for each person
    put instant coffee powder into their cup
    pour hot water into their cup
    stir the contents of the cup
    if they want milk
        add milk to their cup
        stir the contents of the cup
    endIf
endFor
```

The pseudocode editor provides a text editor which facilitates the creation and editing of textual information in a pseudocode format. It maintains a vocabulary of pre-defined words which can be used to structure the control-flow of the pseudocode (words such as ‘if’, ‘while’, ‘for’, etc.). The pseudocode editor recognizes these words as they are being typed by the user and automatically highlights keywords in a different colour as well as automatically inserting required end clauses (e.g. insert an ‘endIf’ to accompany a starting ‘if’ keyword) and also automatically indenting the subsequent lines of text to ensure well-formatted content.

Lines of text within the pseudocode editor correspond directly to objects within the Design-CodeRepresentation tree for the program code procedure currently being edited within design views.

The pseudocode editor ensures that appropriate lines of text are added, modified and/or deleted within the pseudocode to reflect editing of the Design-CodeRepresentation structure as may occur within other code and design views.

For example, assume a new assignment statement is added into a design using the Flowchart Editor. The Flowchart Editor will broadcast an event to all components informing them of the change. When the Pseudocode Editor receives the event, it will detect the presence of the new assignment statement, it will retrieve its textual content, it will determine its placement in relation to its siblings/surrounding elements and parental hierarchy and will ensure that an appropriate line of text is added into the pseudocode to reflect the new assignment. This line within the pseudocode will then be linked to the corresponding element to assist with future edits and placement of text around it.

Similarly, the pseudocode editor recognizes key presses, modifications and also the types of keywords as they are being inserted within its own editor and automatically creates corresponding Design-CodeRepresentation objects to match them and/or changes their Type and other properties accordingly based upon the edits which have taken place.

For example, if someone types the following text on a new blank line within the pseudocode editor, this will result in the creation of a new Design-CodeRepresentation object with its Type set to ‘Assignment statement’ and it's Text set to “f”:

Contents of Pseudocode editor:
f

If the user were to subsequently continue editing this line of text and modify it to now be “fo”, this would result in the Pseudocode Editor detecting the change in text, determining which Design-CodeRepresentation object currently relates to this line, if any, and then modifying the Text property of that Design-CodeRepresentation accordingly.

If the user were to subsequently continue editing this line of text and modify it to now be “for”, this would result in the Pseudocode Editor detecting the change in text AND recognizing that the line of text now starts with one of the recognized keywords in its vocabulary—“for” which may represent a ‘for’ statement. In this case the Pseudocode Editor will determine which Design-CodeRepresentation object currently relates to this line of text, it will modify the Text property of the Design-CodeRepresentation accordingly to now be “for”. The Pseudocode Editor will also automatically add an ending keyword for the ‘for’ statement into the text. It will appear thus:

```
Contents of Pseudocode editor:
      for
      endFor
```

The Pseudocode Editor also provides the following features:

predictive assistance for text entered. For example, recording the names of local or global variables, function names or class names within code and offering these as suggestions during text entry to expedite typing;
copy and pasting of pseudocode, including the ability to copy items from pseudocode and paste them into other design-side views, such as the Flowchart Editor; highlighting of semantically suspect elements, e.g. misplaced ‘else’ statements.

The State Diagram Editor provides a means of creating and editing a diagrammatical representation for a program code procedure in the form of a state transition diagram.

The State Diagram Editor replicates the functionality provided within the Flowchart Editor but catering for the different notation and emphasis on state information—flowcharts focus on control flow, state diagrams focus on movement between ‘states’.

The State Diagram Editor adopts a similar strategy to the Flowchart Editor regarding drawing logic, receiving and posting events to other components, processing of Design-CodeRepresentation objects, creation of ‘wrapper’ objects around Design-CodeRepresentation structures, automatic formatting options, and editability (dragging and dropping items into the diagram, copying and pasting, etc.).

The Data Diagram Editor provides a means of creating and editing both a textual and diagrammatical representation of data structures used within program code.

Data structures can be any of the following: variables; pointers; records or structures; arrays of various dimensions; strings; lists; trees; associations; buffers.

Intuitive graphical representations of these various data structures are provided using a combination of block diagrams and tree structures and which can be automatically generated based upon parsing of corresponding program code constructs or via the input of a dedicated data structure language editor. Automatic formatting and layout are provided as per the Flowchart editor previously described along with options to edit and diagrams manually.

A dedicated data description language is provided and a dedicated text editor, akin to the pseudocode editor previously described, is provided to create and edit data language descriptions. An example of a possible textual representation of a data structure is shown below.

```
Data
      Name: text (20 chars max)
      Address: text (50 chars max)
      Age: integer
      Beverage: Tea, Coffee, Hot Chocolate
End Data
```

The above example shows: name is a text string of up to 20 characters; address is a similar string of up to 50 characters; age is an integer; beverage is an enumerated type which can take on the values tea, coffee, or hot chocolate.

As this text is typed into a specialized form of pseudocode editor the corresponding data diagram will be drawn automatically in a graphical representation window, helping to ensure that the data described is what was intended. A corresponding code skeleton for the data can then be automatically produced. This follows the same conceptual approach for flowchart generation.

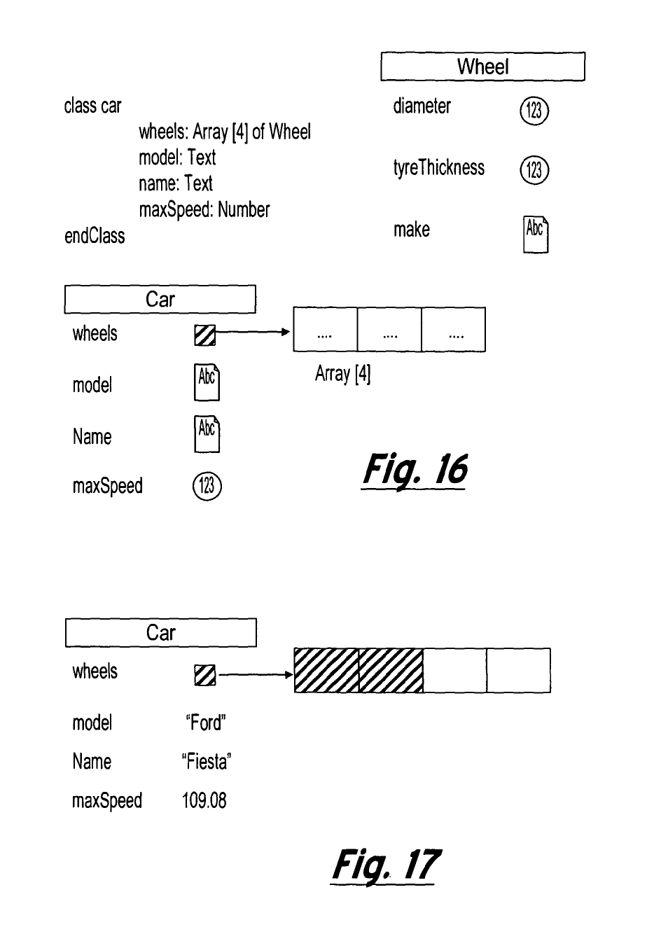

FIG. 16 illustrates a sample of a pseudo language description of a Car data structure along with a corresponding data diagram which utilizes various symbols and drawing logic, including expansion of contained types, to represent the data visually in a format that may be readily understandable to non-programmers.

The design structures, such as data structure diagrams and pseudo language, can be reverse engineered from code.

During the analysis of data structures a type resolving mechanism is provided which allows for consultation of a wider base of sources to resolve any data types declared and which may not have been defined within the immediate context under analysis. For example, if a ‘Person’ data type is encountered during data analysis but for which there is no definition of its type. In this a case a wider search can be conducted utilizing references to additional resources, including code files on disk and other data models in order to seek the definition of the type. In the event that several matching types are found a mechanism is provided to resolve a single choice. Such found types may be imported and saved alongside the data from which they were originally referenced to assist with efficient resolution of types in the future and to improve the ease with which persisted type information can be distributed as a self contained set.

Data structure support is provided for both static and runtime views of code, wherein static means “code held as text within files and any other form of static code editing medium”, such as through IDEs, and wherein runtime means “while the code is actually running live”.

In runtime modes data structure support is offered to assist tasks such as debugging and to provide visualization of the various runtime structures, their values and memory locations, and associations and dependencies present between them.

Runtime information is captured as a mixture of time stamped snapshots and on-demand views, and for which such snapshots or views can be persisted to a storage medium for later recall and playback and analysis. This includes analysis of changes which have taken place between time stamped versions and includes comparison and correlation with related snapshot data and also projection beyond the data sampled.

The runtime views and snapshots are provided on demand at specific breaks during the running of a program, such as debugging breakpoints, either automatically and/or upon manual request and include the use of techniques such as Debugger Visualizers within Microsoft Visual Studio. In addition, an Application Programming Interface (API) is provided which allows existing code to be modified such that, during the running of a program, it can include requests to perform data analysis and visualization at designated intervals and moments and through which the data of interest can be provided and inspected programmatically in order to build a runtime model of its content. Inspection techniques may use, but are not limited to, techniques such as Reflection. For example, the code below shows a Person data structure being created and then utilizing a method call to an API to request a visualization of the data structure and/or to record a snapshot of the data structure for subsequent analysis later.

Person p = new Person( );
DR_VisualizeData(p);

The API provides attributes that can be used to provide additional meta-data regarding the structures to be captured, analysed and visualized. Such attributes are used to include or exclude structures from analysis or to enforce a specific style of visualization of their content and a variety of other properties in line with other aspects of the invention such as constraints, type, and status information. An example is shown below of an attribute being used to indicate that an Array data type (an array of numbers) should be visualized as if its contents contained a Queue (a type of data structure) rather than that normally used for an Array.

[DR(ViewType=”Queue”)]
int[ ] arrayOfNumbers;

The visualizations offered are configurable to allow isolation of or restriction to specific fields of interest within a larger data set, and also offer novelties in the presentation of the values and associations between data. For example, the use of color coding to reflect the size of a numerical value; the use of chart-like visualizations to convey comparisons of the size or extent between different data values; the use of locations within a coordinate system to indicate relativity or size of values.

The visualizations are configurable by the user such that they can modify the symbols selected to convey data and provide their own symbols. They can also modify and combine rule sets which determine how to interpret and present data values visually using a combination of color, shape and placement rules.

The runtime data models provided are editable such that a user may manipulate the actual data values contained within the live data structures in the running program and inject such values into the running system in order to measure their subsequent effects on the program behaviour.

Both runtime and static data models offer various labor saving strategies such as automatic formatting and layout, the ability to collapse and expand fields of interest within data structures, the ability to add or remove visibility of data fields, the ability to conduct searches for fields of interest, the ability to execute queries/commands upon data structures to control the visibility of data fields and their containers, the ability to resolve and display dependencies between data structures.

The data models also allow the user to customize or control the display of certain well-known, built-in data types. For example, programming environments such as Microsoft.NET offer various libraries of pre-defined types such as Stream, Type, TextWriter, etc. When such types are encountered during a visualization the user may wish to reduce their visibility and/or prevent deeper analysis of the contents of these structures in preference to focusing on the custom user-defined types that they themselves have created. In addition the user may also wish to restrict the extent of analysis on their own defined types, should they wish to inspect specific types in more detail than others. A mechanism is provided therefore which allows the user to instruct the data analysis mechanism to restrict the visibility of and/or extent of analysis of the contents of nominated types. For example, by consulting a dictionary of nominated types during a data analysis to subsequently mark certain fields or structures in such a way that the visualization views of the data structures can recognize and present them in a way that indicates their nominated status.

FIG. 17 demonstrates a possible runtime view of a data structure wherein actual values are recorded and displayed for data fields within the Car data structure. The fields for an array of Wheel data structures attached to the car are also displayed but have been limited such that the value of only one of the fields is being displayed (the tyre thickness numerical value). Further, the value of the tyre thickness field is rendered as a colour representation, rather than a raw numerical value, wherein the shade of colour represents the size of the number, e.g. darker shades correspond to larger numbers, lighter shades to smaller numbers.

The design components as described above can be used in two different modes of delivery: (i) an IDE-integrated mode and (ii) a stand-alone mode.

In addition to these two modes of delivery, the design components may also be integrated with other tools commonly required during the software development process, such as, for example, Computer Aided Software Engineering (CASE) tools, project management tools, testing tools and configuration management tools. The design components are integrated with the tools by providing embedded/integrated extensions to the tools in a similar way as that described in relation to the IDE-integrated mode below and importing and exporting data to and from the tools.

Using the IDE-integrated mode, code-side and design-side components are embedded within a software development IDE. Notifications of live edits to program code can be processed. Changes to designs can be conveyed to design components and into the program code itself The following steps take place:

a change takes place within a design component;
a corresponding event is sent to all other components;
design components update their displays to reflect the changed content;
a code-side component may automatically request fresh program code with the changed content and uses this to replace the current code within the IDE window to contain the changed content;
alternatively, a code-side component may only elect to inspect the changed content when instructed to do so manually by the user.

Alternatively;

a change takes place within the program code;
a code-side component detects the change, examines the code, and posts notification of the change to all other components; other components inspect the changed content and update their displays accordingly.

Using the stand-alone mode of synchronisation, components are embedded within an application which is not integrated within an IDE and which typically emphasizes up-front design support but with options for forward engineering of design content into program code and for reverse engineering design information from program code files which are imported into. Edits take place within design-side and code-side components as described and are conveyed to each other to retain synchronicity. Code-design content can be saved and loaded to and from disk. Links/attachments can be formed to code files on disk to subsequently monitor for changes and then re-sync/re-engineer their design content automatically or manually.

The ‘live’ method of synchronization described above adopts a write-replace strategy for synchronization, i.e. if any changes are detected to a program code procedure, simply re-generate a fresh set of design-code information to encapsulate those changes and completely replace and overwrite any previous design information which existed for that same procedure.

The ‘merged’ method of synchronization preserves the content of Design-CodeRepresentation objects between synchronization processing requests. When changes to a particular program code procedure are detected, an attempt will be made to locate the changes and merge them into the existing Design-CodeRepresentations rather than replace the Design-CodeRepresentations with new ones. The reasons for adopting the merged approach are two-fold: (i) a pitfall of the write-replace strategy adopted by the ‘live’ technique is that design information may be lost. When a set of Design-CodeRepresentation objects are created they may be subject to modification by the design-specific views wishing to attach additional information to them. For example, recording cosmetic changes such as adjusting the zoom factor of a diagram or the spacing between or indent of lines in pseudocode.

These changes are irrelevant to code but way wish to be recorded by the design views; (ii) the merged approach allows for a comparison of the old versus the new state of, for example, a program code procedure. Therefore assists with the visualization of those changes for those inspecting and maintaining code.

The merged method of synchronization occurs at a file level (e.g. a program code file such as a .cs file or .java file). However a special case considers merges at lower levels, e.g. at the Class or Procedural level—described later. The file-based merge assumes that a set of Design-CodeRepresentation objects have already been extracted for the program code file in question (using the parse)—for example such as may occur when using a file-based monitoring approach to synchronization. Merged synchronization may then be invoked by electing to compare the currently known design of the file in question (through the existing set of Design-CodeRepresentation objects associated with it) with the contents of the actual program code file it relates to. The merge will be conducted thus:

Parse the contents of the program code file in question (using the technique) to produce a corresponding Design-CodeRepresentation object tree which reflects it content.

Using the method described below, compare the Design-CodeRepresentation tree extracted from the program code with the previously known Design-CodeRepresentation tree for the same file in an attempt to identify those cases where elements may have been modified (for example a program code procedure has been renamed from ‘CheckPassword’ to ‘CheckPasswordIsCorrect’); or where elements may have been removed (e.g. an assignment statement has been removed from a program code procedure); or where an element has been added (e.g. a new Class has been added into the code file in question). These three outcomes will be highlighted in different ways in a subsequent display of the Design-CodeRepresentation objects. For example, a diagrammatic view may elect to colour all additions in green, all deletions in red and all modifications in grey. Any elements which remain the same/unmodified may be coloured neutral/black.

The following novel approach is conducted to perform the merge process, utilizing a ‘best candidate wins’ technique for aligning matches between two sets of information being compared.

Assume we have two trees of Design-CodeRepresentation objects Tree-A and Tree-B, each of which purports to be a representation of the content of the same program code structure (which may be the contents of a Procedure, a Class or an entire code file). The merge will assume that one of these represents the previously known state of the code structure (Tree-A) and that the other represents a newly known state for the same code structure (Tree-B). The strategy then is to seek to match as much of the content in Tree-B with that in Tree-A. Any content in Tree-B which remains unmatched after the merge is assumed to represent new content (it is additional content that the original Tree-A doesn't contain). Any un-matched content in Tree-A is assumed to be content that has been removed (it no longer seems to exist in the new Tree-B version of the content). For any content which has been successfully matched a check will be made to determine the exactness of the match. If the match isn't exact this indicates a modification to the original content.

The matching strategy is conducted in two passes through the Design-CodeRepresentation trees.

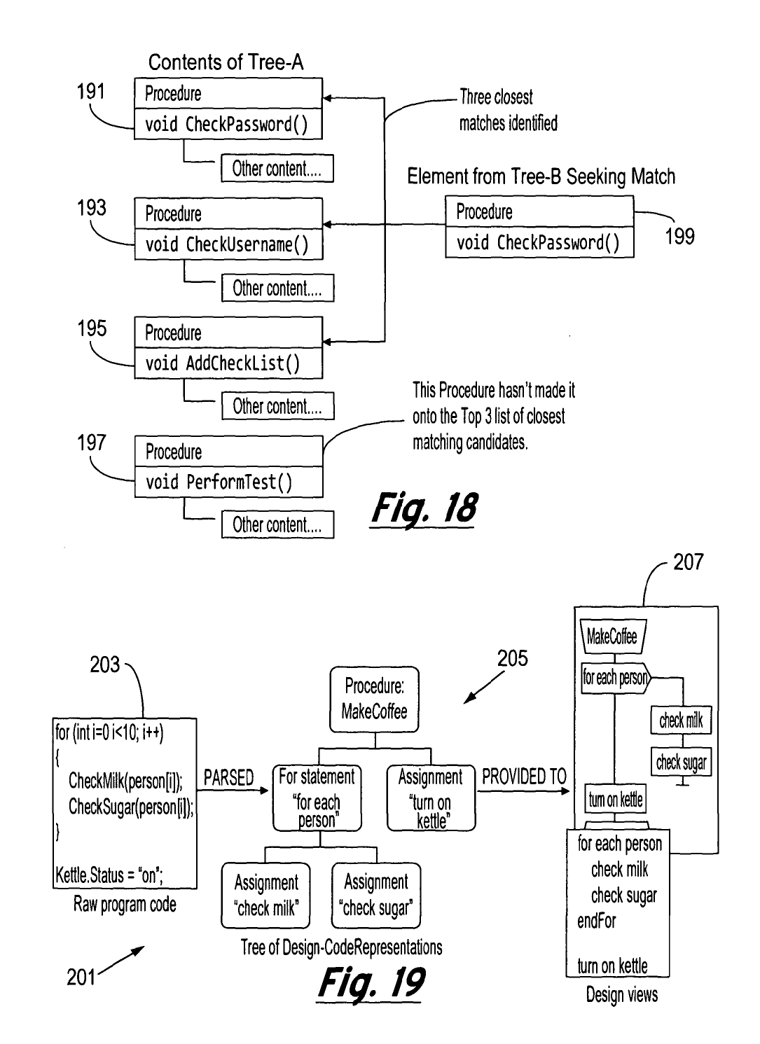

The first pass of the matching strategy is illustrated in FIG. 18 which shows a number of elements 191, 193, 195, 197 as the contents of Tree A and a design-coderepresentation element from Tree B 199 which seeks a match from tree A.

In use, for each Design-CodeRepresentation object in Tree-B 199, a list of candidate matches is identified by performing a complete analysis of the contents of Tree-A. The resultant candidate matches will be recorded and ordered in terms of their closeness of match. For example, if a Procedure object is the next Design-CodeRepresentation object to be processed from Tree-B, the aim is to examine ALL Procedure objects in Tree-A, identify how close they match the Tree-B Procedure (rules defined below) and place the resultant candidate match result in a list of ordered candidates—closest matches at the top of the list, lesser matches further down. The candidate match list will have a limited size (for example 3) so that once the entire Tree-A structure has been processed, only the top three candidate matches will have survived and have been recorded for subsequent processing.

As shown in FIG. 18, for each candidate match 199, the elements in Tree-A 191, 193, 195 which form the target of the match is recorded along with the strength of the match.

The criteria used during the first pass are as follows:

Only consider “like” types when identifying potential matches. For example, if the type of object currently being processed in Tree-B is a Procedure, then only compare against any Procedure objects in Tree-A to identify matches.

Matches don't need to be exact. For example, when comparing the names of two Procedures to determine whether they are a match or not, they don't need to have the exact same name. Instead they can be slightly different, e.g. one may be named ‘CheckOrders’ and the other ‘CheckOpenOrders’. The aim of the comparison is to determine the strength or level of match and to record this numerically. To achieve this the well-known Levenshtein distance text comparison algorithm is used. The Levenshtein distance calculates the number of changes which have to take place to one string of text in order to transform it to another. The resultant number provides the levels of ‘closeness’ between the two strings. A result of 0 (zero) indicates that zero changes were required to transform one string to another, i.e. they are exact matches. For example, assume the following two strings “The cat” and “The cat sat”. The number of changes requires to transform the first string into the second is 4 (adding “sat” to the end of it). Therefore the Levenshtein distance is 4. Whereas another string “The cat is” only has a distance of 3, therefore would be considered a closer match to the first string.

It is allowable for a single element in Tree-A to be matched to more than one element in Tree-B once the first pass has been completed. Tree-B elements don't have exclusive ownership of the Tree-A candidates they are matched to. Indeed, it is possible that subsequent elements in Tree-B, when compared to this same Tree-A element, may have an equally valid claim on it, perhaps even having a stronger match with it. The purpose of the first pass is to allow elements in Tree-B to stake a claim on any of the elements in Tree-A that they seem most closely matched with in order to ascertain their top/best/strongest match and also several secondary/in-reserve matches which can be deferred to should their top choice become unavailable.

When performing a comparison of an element, the following rules apply.

Use both the code and comment text to determine the closeness of match between two Design-CodeRepresentation structures. Using code content alone may result in incorrect matches (although the opposite may also be true). For example, assume the following piece of code:

```
// initialize the size of the screen margin
int margin = 10;
// if the drawing area is clear
if (gd.IsClear)
{
    // initialize the drawing area margin
    int margin = 10;
}
```

If using code only to match elements together, there are two assignments in the extract above which have the same code “int margin=10;” so will produce the same result in terms of level of match with anything they are compared against. If we were searching for a piece of code such as “int margin=10” it would be difficult to know which of the above was being sought. It would be possible to use surrounding contextual information (i.e. examine any sibling lines of code around the elements in question to determine their closeness to the element being sought). It may also be possible to consider the parental position of the elements—in the above extract one is contained in an ‘if’ statement, the other is not. However, these modifications would preclude the possibility that the item of code being sought may previously have existed outwith an ‘if’ statement but has now been moved into one. Using a combination of both comments and code may increase the chances that the correct element is identified.

If the element is composite, i.e. can have child elements within it (such as a Class or Procedure or code structures such as ‘if’, ‘while’ and ‘for’ statements)—as well as checking the level of closeness of match of the element itself, also examine its content. For example, when comparing two Procedures to determine if they may be possible matches, as well as comparing their names to each other, also compare how closely matched their content is. This would resolve the situation where two procedures have the exact same name (because they are two different overloaded versions of the same method) but which have different content and which may otherwise be difficult to distinguish between.

For certain structures such as Procedures, incorporate their parental hierarchy in the comparison to determine their level of closeness. There may be cases where two different classes contain the exact same procedure, with almost the exact same content. If the name of parent class is incorporated into the match-checking process this may assist in the distinction between these two similar procedures. However, when seeking procedures for matching purposes it may not be possible to assume that a Procedure must always belong to a certain previously known Class. The Class may be renamed or the Procedure may be moved into a different class.

Having conducted the first pass, this will result in every element in Tree-B having been matched to at least one potential candidate match within Tree-A. As mentioned previously, each Tree-B element has only tentatively staked a claim on the Tree-A elements they appear to be most similar to. The purpose of the second pass is to now examine these tentative claims in more detail and to whittle them down to so that each Tree-A element only has at most one Tree-B element staking a claim of match against it. The second pass requires the following, for each element in Tree-B:

Examine the Tree-A element which represents the top/strongest match for the Tree-B element in question and determine if this match is still available—each Tree-A element will record whether it currently has a Tree-B element which has claimed it and a record of the strength of the claim/match.

If the Tree-A element has no Tree-B element currently claiming it, the Tree-B element in question can register itself as the claimant and record the strength of its

If the Tree-A element already has a claim from another Tree-B element, the strength of the claim will be examined.

If the strength of claim currently on the Tree-A element is greater than that which could be provided by the Tree-B element in question, then the Tree-B element in question will relinquish its hopes of claiming this Tree-A element and will instead turn its attention to examining the next strongest match that it has on its list of possible matches. The above steps will then be repeated for the Tree-A element which forms the next strongest match for the Tree-B element in question. If the Tree-B element in question has consulted all of the possible matches that were tentatively aligned with it and found them all to be already claimed by other, more strongly matched Tree-B elements, then the Tree-B element in question will have reached the end of its search without a successful outcome/match.

If the strength of current claim on the Tree-A element is less than that which could be provided by the Tree-B element in question, then the Tree-B element in question will register itself as the new claimant for the Tree-A element and will record the strength of its claim. The Tree-B element which previously held the position as claimant will be informed that it has had to relinquish its position as claimant which will result in that Tree-B element re-consulting its own list of candidate matches and attempting to align itself with any of its next-strongest matches, using the approach outlined previously, until it can find another Tree-A element to align with or none at all.

If the strength of current claim on the Tree-A element is the same as that which would be offered by the Tree-B element in question, then, assuming a first-come first-served basis, the Tree-B element in question will relinquish its hopes of claiming this Tree-A element in favour of the Tree-B element that got there before it. At the end of the second pass, each Tree-B element will either be aligned with exactly one Tree-A element, or none at all. Each Tree-A element will have exactly one Tree-B element matched with it, or none at all. Each match will be exclusive, i.e. it is not possible to have two different Tree-B elements matched to the same Tree-A element.

If any Tree-B elements are left un-matched, they are assumed to represent code structures which are new additions to the code represented by the Tree-A structure. (Tree-B represents the newest known state of the code, Tree-A represents the previously known state). If any Tree-A elements are left un-matched, they are assumed to be elements which are no longer present in the newest version of the code (as represented by Tree-B), therefore elements which have been deleted. For each match between a Tree-A element and a Tree-B element, if the strength of the match is not zero, therefore is not an exact match (as per the Levenshtein distance), then it is assumed that the Tree-B element represents a modified form of the Tree-A element, e.g. perhaps the Tree-A element is a procedure which had the name “CheckPasswords” but this now appears as “CheckUserPasswords” in the corresponding Tree-B element. Using the above information regarding additions, deletions, modifications, it is possible to present this information visually. For example: (i) display a textual summary of the contents of both Tree-A and Tree-B and indicate, using colouring of text, those instances of additions, etc. identified; (ii) display a textual summary of the contents of both Tree-A and Tree-B and, using connecting lines between the two sets of information, highlight the matches identified between them; (iii) merge the content of both Tree-A and Tree-B together into a single tree of Design-CodeRepresentation objects which is then presented in visual form (such as a diagram or flowchart) and within which colouring can be used to indicate which portions of a code structure may have been deleted, added or modified.

Using the merge approach facilitates the highlighting of differences between two structures (e.g. two procedures). In this case: parse the code or design information for each structure—attempt to match them together and then highlight where they differ, e.g. show deletions, additions and modifications.

Various of the synchronization methods described herein utilize a Design-CodeRepresentation data structure which acts as a unifying, two-way bridge between program code and its corresponding design documentation. Design-CodeRepresentation objects are typically produced as the output of parsing program code to extract design-relevant information, and which are subsequently passed to design views for processing. Design-CodeRepresentation objects can also be produced by design views themselves and for which program code can subsequently be forward engineered from.

FIG. 19 is a block diagram 201 which shows raw program code 203 which is parsed to form a tree of design-coderepresentations 205 which is provided to design view 207.

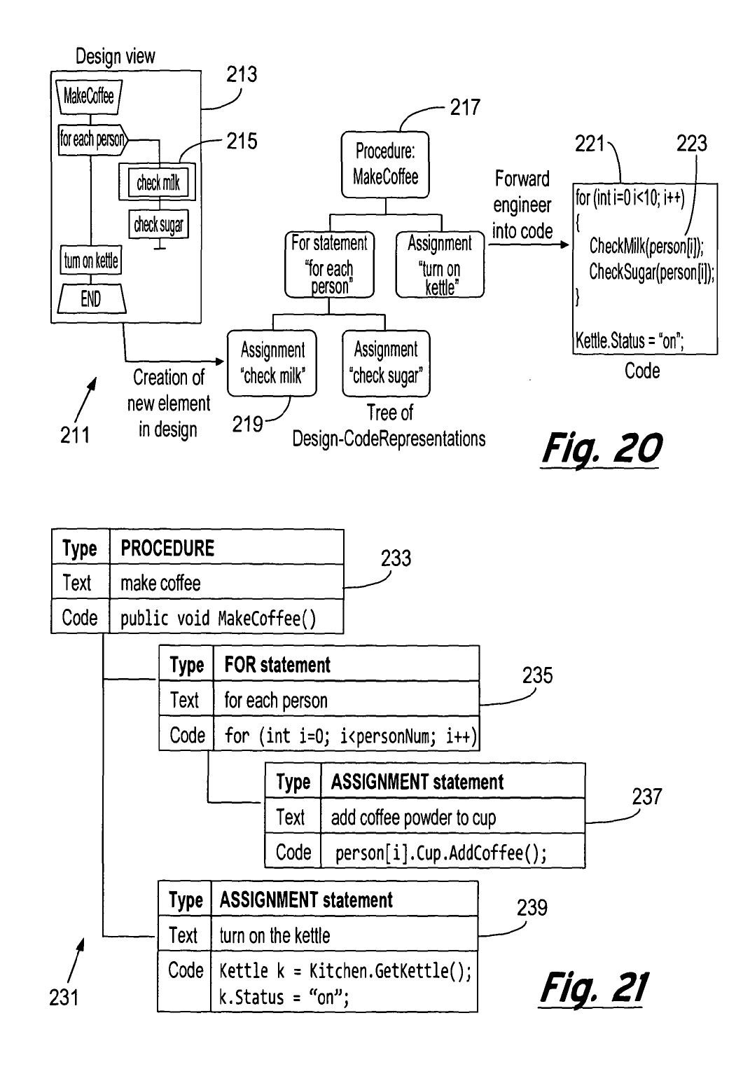

FIG. 20 is a block diagram 211 which shows a design view 213 wherein a new element 215 has been created. This then creates a new element 219 in the Design-CodeRepresentation 217 which is forward engineered into the code side 221 as a piece of code 223.

Design-CodeRepresentation objects represent all structures which would be expected to appear within program code files, e.g. Packages or Namespaces which may contain

Classes which may contain Attributes, Properties and/or Procedures, the latter of which may contain various code constructs such as ‘If’ statements, ‘While’ statements, ‘For’ statements, or Assignment statements (e.g. statements such as ‘int x=10;’ or ‘CheckUserPassword( );’).

A separate Design-CodeRepresentation structure would be created to hold any constructs when encountered during code and a subsequent tree hierarchy created to maintain any parental/containing relationships between them, e.g. a Procedure which contains an ‘If’ statement which contains an Assignment statement.

FIG. 21 shows an example of a Design-CodeRepresentation object 231 which holds both code specific and design specific information. Code specific information is the actual code itself, e.g. for the ‘For’ loop 233 it may be “for (int i=0;I<personNum; i++)”. Design specific information is an abstract textual representation of the corresponding code it relates to, e.g. for the ‘For’ loop mentioned above, the design information may contain a more reader friendly description of the intent of the ‘For’ loop such as “for each person”. Additional information records the type of element (whether it is a Procedure 233, ‘For’ statement 235, Assignment statement 237, 239, etc.).

Components on the code side or design side may elect to ‘wrap’ additional data around the core Design-CodeRepresentation object. For example, code side views may wish to record the start and end lines within a program code editor which the code contained within a Design-CodeRepresentation object relates to. Individual components will typically create their own ‘wrapper’ hierarchies which contain the base Design-CodeRepresentation structure but around which additional data is attached.

The Design-CodeRepresentation structure provides a single conjoined source of program code and corresponding design information from which all associated views (design and code) can derive the information they require to present and update their information.

The present invention also allows a user to browse and modify un-committed design edits for sections of code by storing these edits in a cache.

The caching of these edits ensures that any uncommitted design changes are not lost as the user moves from one section of code to the next thereby allowing the user to return to a previously edited design at a later point to further edit it and/or commit the changes to code or to throw-away the changes.

It allows the user to do the following:

a. Click on a section of code (X) to view its design
b. Make modifications to the design BUT without committing any changes to code (X) just yet
c. Click on a different section of code (Y) to view its design
d. Prior to viewing the design for code (Y), the modified design for code (X) is stored in an internal cache to preserve the un-committed changes it contains.
e. The design for code (Y) is then displayed.
f. The user clicks back on the previous section of code (X). This has the result of retrieving the previously held/cached version of the design for this code—which now includes some un-committed changes. So at this point the code (X) and its corresponding design are being displayed alongside each other but contain differences i.e. there are things in the design which are not yet in the code.
g. The user may choose to further edit the design, commit the changes to code and/or throw the changes away.

The key benefit of the above is that the user doesn't just need to work on a single piece of code at a time—they can switch between different sections as part of a holistic design activity and can ensure that design changes are preserved as they move from one section of code to another and back again. So a persisting of un-committed changes throughout an entire design editing session. This allows the user to be working on the designs of several different pieces of code at the same time, each of which being held in an internal cache in an un-committed state.

Auto-saving of un-committed design edits is provided and is akin to the ‘autosave’ feature that you typically find in Microsoft Word® where it will automatically save a backup copy of the document you are working on every few minutes in the background to prevent you losing anything in the event of a program crash. As described above it is possible for a user to be working on the designs of several different sections of code at the same time. Or, to put it another way, they may have several designs residing in an internal cache which have unsaved (un-committed) changes. If the host program (Visual Studio) were to crash or exit then the uncommitted design changes would be lost.

Therefore, the present invention can periodically save the contents of any in-edit designs to disk so they may be recovered during a later/subsequent session. This would be achieved by a timer periodically checking the contents of the internal cache of un-committed designs and saving them to a backup file on disk.

In addition, embodiments of the present invention provide functionality that allows for the saving of design information to disk. For example, it is possible to save the Design-CodeRepresentation structure for a code base (could be a section of code, an entire component or an entire code project comprising many files) to disk at any time—not just as part of an auto-save/backup strategy. This allows for opening and perusal and editing of the design content on its own, away from the actual code to which it corresponds.

Another feature of the present invention provides for the automatic generation of abstract design information if this information is not present in the code-side. Design synchronisation usually requires abstract descriptions of processes within the code being examined to be sought, typically by locating comments within code. However, if the code is un-commented the present invention can attempt to create its own abstract description of the code so it can present something more meaningful to the design views rather than just raw code.

Another feature of the present invention allows for the synchronisation of positional information as well as content within code-side and design-side views. For example, if a particular item is selected in a section of code (such as an ‘if’ statement) the present invention will ensure that the corresponding associated element within the design views is also selected and will be scrolled into view within the design displays if it happens to be off-screen. The opposite is also true. If the user clicks on a specific element in a design view (such as a ‘for’ statement) then the present invention will attempt to ensure that the corresponding section of code is scrolled to/visible within the software development environment.

This feature of the present invention provides navigational synchronisation as well as content synchronisation. This can be very important for larger sections of code that don't fit in their entirety into the available screen space and instead rely on scrolling up, down, left, right to view.

Another feature of the present invention allows for the drawing of diagrammatic design with labour-saving devices (automated placement and positioning of ‘boxes’ and automatic generation of ‘lines’). Drawing a diagram is typically something which is labour intensive, requiring placement of boxes on a drawing space, moving boxes around, lining them up and then drawing lines to connect them, shifting other boxes and lines around later to accommodate the addition of new boxes in between them—all of which can be fiddly and time consuming. The user only has to drag and drop a box onto the drawing space. All of the other steps are automatically performed for them: moving boxes into their locations, lining them up, connecting lines between them, moving other boxes and lines around automatically to accommodate changes in between them. This effectively reduces by 80% or more the time required to create the diagram.

Another labour-saving device is that diagrams can be automatically generated by typing in some pseudocode. Typing a process in a textual form takes far less time than even the time-saving dragging and dropping process described above.

In some embodiments of the present invention, the code-side and design-side components have the ability to detect certain semantic errors within program code (e.g. the misplacement of certain keywords or control structures) and, in which case, can also highlight such cases to the user across the code and design views. For example, colouring of text or symbols in the pseudocode and diagram views.

Some embodiments of the present invention support generation of program code from design information (and vice versa) as well as test information. For example, when a piece of code is written it would be common to write some corresponding tests (also in program code) that operates the code to ensure it behaves appropriately, e.g. try different input values into the code, test boundaries of certain values. Code generated, from any such code generating capabilities, encompasses both structural and behavioural aspects of the code. For example, generated code may automatically produce a class structure for a Binary Tree, it may automatically generate functions to add and remove items from that tree as well as conduct searches and perform validation of data fields, including range checking and exception handling.

Embodiments of the present invention can also include the ability to attach additional information to any code-side or design-side element which will support the needs of a variety of tasks on a software project such as project management, review, testing. For example, for any block of code (and its associated design element(s)) information can be attached which describes the last time it was reviewed, the last time it was edited, the average time spent editing it, a record of whether it has been tested or not. This information will be gathered and recorded either directly within program code or stored separately as design-side information. The code-side and design-side views can then highlight this information if they wish to, e.g. the diagram view can use different symbols, adornments or colouring to highlight whether certain elements have been subject to testing or not.

Embodiments of the present invention can also take two different design representations which represent an old and new version of the same block of code. Two items may be compared/merged to produce a single design representation with the combined content of both. Within this single representation the differences between the documents can be highlighted during the merging process This provides a merged synchronisation between the old and new versions of a block of code but with the addition that during the merge process information about deletions, additions, modifications, etc are recorded so these can be highlighted in code-side and design-side views if required.

The present invention also provides a novel parsing technique to facilitate extraction of detailed design information from program code.

Traditionally the purpose of a parse is to examine and process the contents of textual code to compile it into an executable form so it can be run as a program. A ‘grammar’ will be defined which specifies predefined ‘tokens’ of interest during the parse as well as certain rules regarding their position/relationship to each other. Due to the formal rules adopted by the parser regarding the syntactical placement of elements and additional tokens it may identify during the parse (such as data variables declared by the programmer) a parse may detect and report errors in coding, e.g. missing or misplaced symbols, undeclared variables, etc.

The recursive descent approach is a very common example of one of a number of approaches to parsing program code. The recursive descent technique has been adapted to improve its suitability to parsing detailed design documentation within program code, in particular in relation to the processing of comments within code. These adaptations are now described.

The first key adaption is a relaxing of the formality with which the parse is conducted with respect to code which may otherwise cause compiler errors. For example, the following pieces of code would cause problems:

intx =10; (should be ‘int x = 10;’)
for (int i=0 i<10 i++) (should be ‘for (int i=0; i<10; i++)’)

The first line of code above may cause problems because a space is missing between ‘int’ and ‘x’ which means the data type ‘int’ may not be recognized and ‘x’ won't be recognized as a data variable being initialized. The second line of code has semi-colons missing from the conditional section of the ‘for’ statement which would typically cause a compiler to complain during a parse of such content. The parsing technique as being described here would not have issue with the above lines of code. The first line of code would be parsed and assumed to be an assignment statement. The second line would be parsed and assumed to be a ‘for’ statement.

The intention of the parse of the present invention is not to provide error reporting for misplaced symbols or syntactical errors. Nor would it validate the syntactical correctness of the above lines of code. Rather the intention of the parser of the present invention is only to be able to glean enough information regarding the program code that would allow it to determine which code structures are present, i.e. is it an assignment (which any line of code is assumed to be unless can be proven otherwise), or is it a ‘for’ statement (as indicated by the presence of the ‘for’ keyword), etc.

The parser of the present invention performs its parse using the grammar as would be expected for a programming language, so it can detect when ‘for’ loops start and end as would be expected of a typical parser. It can detect where the conditional section of an ‘if’ statement may be.

However, the parser of the present invention doesn't interrogate the inside of the ‘if’ conditional section. It could contain un-compilable code as far as the parse is concerned. The reason for this relaxation is that the parser of the present invention needs to be able identify the key points of control flow within a procedure such as ‘if’, ‘while’, or simple assignments. The primary aim is then to be able to convey these structures in a more abstract form to design views. As the parse proceeds and the various code structures are identified a tree of corresponding Design-CodeRepresentation objects will gradually be created to reflect the content of the code.

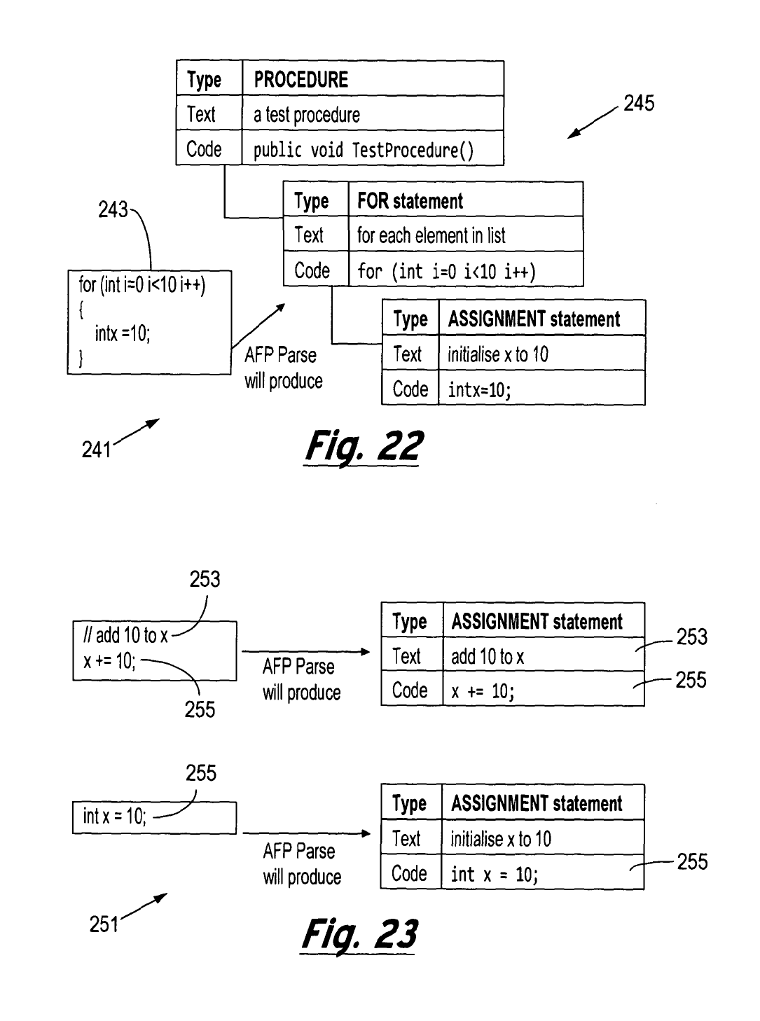

FIG. 22 is a block diagram 241 which shows lines of code 243 being parsed to produce design-coderepresentations.

Another key adaption of the parser of the present invention technique from a traditional recursive descent parse is with respect to comments. Typically a parser may ignore algorithmic level comments (those occurring inside a procedure) or indeed any comments in the code because the comments are there to improve the readability of the code for the programmer and have no effect on how the resultant compiled program actually runs.

Parsers will recognize comments as part of their grammar but usually as means of being able to locate and move past them during the parse to then process any subsequent lines of code. The parser of the present invention adopts an approach which goes against the conventional approach and in many respects adopts the opposite approach. The primary intention of the parser of the present invention is to actively locate content within the program code which may provide useful data for the design views. Typically this comes in the form of comments within code which describe what the code is doing in a more abstract, human readable form.

Therefore comments are considered one of the top priority pieces of data being sought during the parse, taking precedence over code in terms of their information content—crucially this occurs at the detailed design level within the contents of procedures, rather than stopping at the ‘header’ level of procedures and ignoring their content as may typically occur with other forms of documentation parser. During the parse when a comment is identified it will be recorded within a corresponding Design-CodeRepresentation object. If there is any code adjudged to be associated with the comment, typically by being on a line immediately adjacent to the comment, this code will recorded and placed alongside the comment in the same Design-CodeRepresentation object—see FIG. 23.

FIG. 23 is a block diagram 251 which shows another example of parsing in accordance with the present invention, including merging of comment 253 and code 255 data into Design-CodeRepresentation objects.

Further adaptations implemented by the parser of the present invention relate to the decisions regarding the merging of certain code constructs based on their adjacency to each other and/or their adjacency to comment text. These adaptations will be described later. However, prior to that, a walkthrough example of what may typically occur during a parse, using a PARSER OF THE PRESENT INVENTION, of program code is provided. Assume the following piece of code is being parsed:

Line 1: // if password is correct
Line 2: if (GetPassword( ) == “abc1234”)
Line 3: {
Line 4: // allow user to proceed
Line 5: Page.Authenticated = true;
Line 6: }

The parser of the present invention parse will proceed thus:

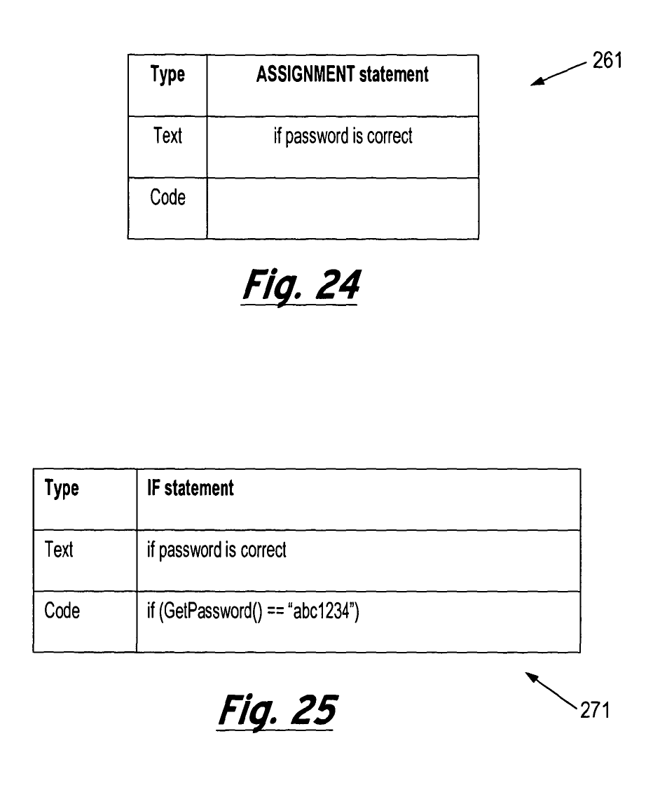

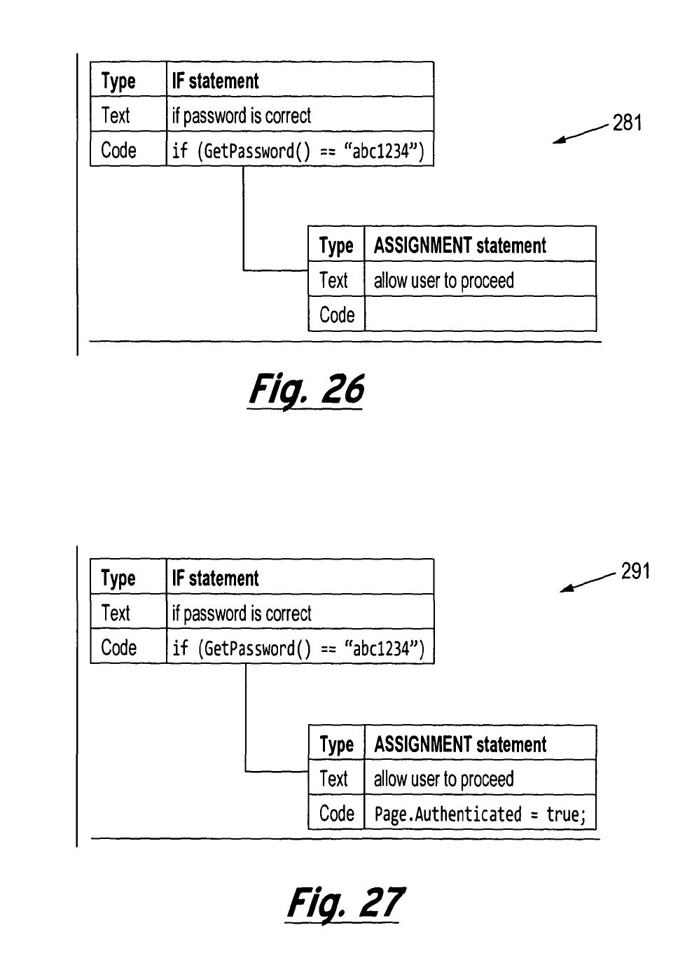

Line 1: Non-white space tokens will be detected on the line. In this case it will be detected that the line begins with characters that signify a line-based comment in the code (‘//’). The parsing logic will attempt to read all remaining characters on the same line which will form the comment text. A Design-CodeRepresentation object will be created to hold the comment text. By default the Design-CodeRepresentation object will be assumed to be of type Assignment statement, until proved otherwise. No ‘Code’ content will have been identified for the Design-CodeRepresentation object as yet.
Line 2: Non-white space tokens will be detected on the line. It will be detected that this line is an actual line of code, i.e. it isn't a comment. It will also be detected that this line is immediately adjacent to the comment that was parsed in the previous line. Therefore the line of code that is about to be processed is something that will be merged with the comment text above as part of a single, higher level Design-CodeRepresentation object. The parser will initially assume that the line of code represents a simple assignment statement. However, as the parse proceeds the presence of the ‘if’ keyword, will be detected. At which point the parser will switch to parsing the content as an ‘if’, i.e. it will expect a conditional section to follow enclosed within ‘(.)’ brackets which may be spread over 1 or more lines. Once the conditional information has been parsed, the entire line(s) of code will be merged within the Design-CodeRepresentation object which was created previously for the comment on the immediately preceding line of text. The Type of the element will be modified from Assignment statement to reflect the true nature of the code which the comment on the preceding line relates to it—which is in actual fact an ‘if’ statement. The Code property of the Design-CodeRepresentation object will be set. The parsing of the ‘if’ statement will then continue. The parser will expect any ‘child’ content of the ‘if’ statement to now follow on subsequent lines of code, typically enclosed within { . . . } brackets but may also be bracket-less content on subsequent adjacent lines. As shown in the table 261, FIG. 24.
Line 3: As part of continuing ‘if’ processing the start bracket ‘{’ will be identified to signify the beginning of the enclosed content of the ‘if’ statement. The parser knows that, until a closing end bracket ‘}’ is found, any subsequent lines of code will be regarded as ‘child’ elements of the ‘if’ statement. As shown in the table 271 FIG. 25.
Line 4: Non-white space tokens will be detected on the line. In this case it will be detected that the line begins with characters that signify a line-based comment in the code (‘//’). The parsing logic will attempt to read all remaining characters on the same line which will form the comment text. A new Design-CodeRepresentation object will be created to hold the comment text. By default the Design-CodeRepresentation object will be assumed to be of type Assignment statement, until proved otherwise. No ‘Code’ content will have been identified for the Design-CodeRepresentation object as yet. This new Design-CodeRepresentation object will be added as a ‘child’ to the previously created Design-CodeRepresentation object which represents the parent ‘if’ statement. As shown in the block diagram 281 FIG. 26.
Line 5: Non-white space tokens will be detected on the line. It will be detected that this line is an actual line of code, i.e. it isn't a comment. It will also be detected that this line is immediately adjacent to the comment that was parsed in the previous line. Therefore the line of code that is about to be processed is something that will be merged with the comment text above as part of a single, higher level Design-CodeRepresentation object. The parser will initially assume that the line of code represents a simple assignment statement and will attempt to parse it on that basis, e.g. parse until a terminating semi-colon is reached. Once the line of code has been parsed it will be merged within the Design-CodeRepresentation object which was created previously for the comment on the immediately preceding line of text. The Type of the element will remain as Assignment statement. The Code property of the Design-CodeRepresentation object will be set. As shown in the block diagram 291, FIG. 27.
Line 6: A closing ‘}’ bracket will be encountered. This will signify the end of the ‘if’ statement enclosed content. Any subsequent lines of code encountered after the ‘}’ bracket will be considered siblings of the ‘if’ statement rather than ‘child’ elements.

The parse reaches the end of the code.

Additional adaptations in the parser of the present invention technique which transcend the base recursive descent parse are described below.
comments adjacent to lines of code are assumed to be design information pertaining to that code and will be linked/associated within a single Design-CodeRepresentation object.
Blank lines between lines of code signify separation between design-level elements
Multi-line comments are processed such that the first line is regarded as the abstract description of any following lines of code and subsequent comment lines form a ‘Notes’ property which is placed within the resultant Design-CodeRepresentation object which is created.
If several lines of code on adjacent lines are adjudged to be assignment statements (i.e. they don't contain any ‘for’, ‘if’, ‘while’ or other complex keywords) they will all typically be grouped together as a single block of design information and will all be recorded together within the Code property of a single Design-CodeRepresentation object.
If several lines of code on adjacent lines are adjudged to contain a mix of different coding structures, e.g. the first line is an assignment, the second line is an ‘if’ statement) the PARSER OF THE PRESENT INVENTION parser would, by default, split these into separate design elements—even although they are on adjacent lines—because they represent different control-flow structures. In this case, two separate Design-CodeRepresentation objects will be created, one for the assignment statement code and one for the ‘if’ statement code.
Adjacent merge: an option is provided to allow the parser to merge two or more different code constructs which appear on separate but adjacent lines so they are placed within a single Design-CodeRepresentation object (in contrast to the previous point immediately above).
If no comments are provided for a line of code the PARSER OF THE PRESENT INVENTION parser automatically guesses or provides these.
A blank line between and ‘if’ statement and it's starting bracket ‘{’ will cause the parser to recognize these as two separate structures. The first being an (incomplete) ‘if’ statement. The second being what is known as a ‘bracketed’ statement. A bracketed statement represents any lines of code which have been contained within ‘{’ and ‘}’ brackets and which do not appear to belong to any other structure, such as an ‘if’, ‘while’ or ‘for’.
Tagging of elements is applied to affect grouping:
   A lightweight tag groups all of the content of the immediately adjacent code structure into a single design element.
   An opening and closing heavyweight tag may enclose miscellaneous code structures spanning multiple lines in order to group them together into a single design element.

The present invention also allows for the insertion of attributes/tags into code that offer additional meta-data to guide and instruct the parse and allow it to glean additional content for the structures being parsed. Such attributes are injected into code during automatic code generation tasks performed by the invention. For example, the code extract below shows an integer variable being declared within code, above which an attribute has been defined which provides additional data about the variable during the parse. In this case, offering the expected range of values for the numerical variable being declared. Such attributes may indicate constraints, properties and type information for the code as well as status information.

[DR(Range=“13 to 15”)]
int age;

During parsing, if a line of code is encountered which does not have any comment above it the PARSER OF THE PRESENT INVENTION processor will automatically generate comment text for the code line so as to be able to provide something useful/human readable to the design views to display. Examples of commented and un-commented are shown below.
Commented code:

// add 10 to the value of X
x += 10;

Uncommented code:

x+=10;

The commented code will be parsed as normal. The comment text will be read in. A Design-CodeRepresentation object will be created to represent this in-progress design structure (in-progress because subsequent lines of code will form part of it too, but yet to be parsed) and its Text property set to the comment text. The subsequent line of code will be read in and stored within the Code property of the same Design-CodeRepresentation object, therefore appearing thus:

| Type | ASSIGNMENT statement |
|---|---|
| Text | add 10 to the value of x |
| Code | x += 10; |

Processing of the un-commented line of code is slightly different. The line of code will be parsed and it will be detected that there is no corresponding/adjacent comment provided for it. A new Design-CodeRepresentation object will be created to hold the Code property for the line of code parsed. Then, at this point novel comment generation logic will be applied. The system shall attempt to generate its own high level comment for the code, something which can be used more usefully by the design views—rather than providing them with just raw code. The comment generation logic will examine the line(s) of code associated with the DesignCodeRepresentation object in question and attempt to provide a more natural language translation for it—which will subsequently be placed in a ‘Text’ property of the Design-CodeRepresentation. The comment generation logic uses knowledge of programming keywords and symbols and transforms them to their natural language equivalent using the strategies described below.

Common symbols such as ‘==’, ‘=’ and ‘<’ can be translated to their natural language equivalents (‘equals’, ‘initialise to’ and ‘less than’ respectively). Certain programming keywords such as ‘if’ are already in a form which is natural language. Certain symbols such as ‘(‘ . . . ’)’ brackets can be ignored during translation. Examples below:
The code “int x=10;” can be translated to ‘initialise x to 10’
The code “if (x<y)” can be translated to ‘if x is less than y’

The de-referencing operator indicates ownership and, in certain situations, can be translated to an apostrophe or alternative ownership grammar. For example, assume the following code:
person.Height=x;

The ‘.’ operator indicates that ‘Height’ is an attribute that belongs to the ‘person’ object. The ‘=’ operator indicates that the value of this attribute is being set to ‘x’. Based on these findings, the parser can generate a translation of this above line of code into the following forms:
“person's height is set to ‘x’” OR
“height of person is set to ‘x’”

Many program functions are named using common words, typically verbs, which the parser can recognize and have pre-defined translations for. For example, common words used in functions are ‘get’ and ‘set’. The presence of these words may offer opportunities for certain phrases. For example, you may typically state ‘set’ value of something to; ‘get’ value of something. Additional examples are: ‘add’ value/amount/item to; ‘deduct’ value/amountfrom; ‘apply’ something to; ‘check’ that; ‘ensure’ that; and so on. So we may offer the following translations (which demonstrate a combination of recognized phrases and dereferencing notation to indicate ownership):
person.SetHeight(30); can be translated to “set height of person (to 30)”
Person.GetHeight( ); can be translated to “get height of person”
Cup.AddCoffeePowder( ) can be translated to “add coffee powder to cup”

In other instances, the presence of certain common key words may be ignored, particularly if multiple stages of de-referencing are involved. For example, consider the following line of code:
person.GetCup( ).AddCofferPowder( )

The first function call (GetCup( )) retrieves the person's cup. The second function call then adds coffee powder to that cup. A straight translation of this using the strategies described above so far may produce something such as the following:
“get cup for person and add coffee powder”

The word ‘and’ replaced the second dereferencing operator in what is provided as a left to right translation of the line. This translation is quite adequate. However, if we were to detect that multiple de-reference operators are present, we may be able to strip out certain common words such as ‘get’ and ‘set’ and affect a right to left translation of the line. The first de-reference pair (person.GetCup( ) can be translated to “person's cup” (the ‘Get’ word has been ignored). The remaining de-reference can then be applied to the first de-reference pair which would result in a complete translation thus:
“add coffee powder to person's cup”

More complex cases may cause imperfections in translation. For example:
personList.GetPerson(i).GetCup( ).AddCoffeePowder( )

Adopting the rules previously specified, this may produce translations such as: “get person of personList and get cup and add coffee powder” OR “add coffee powder to cup to personList's person”

Aberattions or imperfections are to be expected as the minutiae of complex code are encountered. In some cases the aberrations are a helpful indicator that a piece of code hasn't been commented properly and should perhaps be revisited by the programmer. However the translation logic is extendable to accommodate new cases as they are discovered, for example by building known grammars of translations for commonly encountered words and also providing user-editable templates to replace pre-defined phrases encountered, e.g. anytime the phrase “for (int i=0; i<10; i++)” is encountered in the code, translate this to “traverse elements of list”.

Contextual information is also to assist translation, for example variable declarations in code. Assume the following code:

Person p = new Person( ) ; // create instance of new person object
if (p.Height( ) > 0)
{
}

The second line of code (if (p.Height . . . ) would normally translate as ‘if Height of p is greater than zero’ BUT by recognizing that ‘p’ is a object of type ‘Person’ declared previously in the code we can replace ‘p’ with ‘person’ and re-translate the line ‘if height of person is greater than zero’

If a ‘cast’ is encountered within code, the resultant cast object type is what will be processed during translation. For example, assume following line of code:

if (((Person)person[i]).Height > 10)
{
}

The casted section ((Person)person[i]) will simply be regarded as translating to ‘Person’—which is the actual output of the cast itself. The remainder of the translation would appear thus: “if person's height is greater than 10”.

In some cases, it is possible to ignore anything to the left of the first de-reference operator and still produce a translation which is acceptable. For example, consider the following:

Person.GetHeight( );
person.GetCup( ).AddCofferPowder( );
if (((Person)person[i]).Height > 10)
{
}
personList.GetPerson(i).GetCup( ).AddCoffeePowder( );

These may translate to the following:
“get height”
“add coffee powder to cup”
“if height is greater than 10”
“add coffee powder to person's cup”

In all cases the left-most de-reference has been ignored. In the latter case, as well as the left-most de-reference being ignored, the resultant starting point has been adjusted to be ‘GetCup( )’ and which has been processed using the right-to-left approach which attempts to apply anything after the first de-reference (“add coffee powder”) to the content to the left of the first de-reference (“GetCup” or “cup” assuming the rule of stripping common words such as ‘get’ and ‘set’ are applied as described previously). Again, the above rules do not always produce something which is immediately readable. Consider the following:

if ((Person)person[i]).Cup.HasMilk( ) == true)
{
}

Possible translation of this using the above rules would be:
“if person's cup and has milk”
“if cup's has milk”
“if cup has milk”
“cup for person and has milk

The presence of the word “has” can be recognized in code phrases which can suggest an alternative translation strategy. For example, code such as “Cup.AddCoffee” can be translated to “add coffee to cup” whereas applying the same translation rules to “Cup.HasMilk( )” would produce “has milk to cup”. But, recognizing the presence of ‘Has’ and its typical grammatical positioning it may offer the opportunity to produce translations such as the following: “cup has milk”—in which case the reversing of words typically applied when encountering a de-reference operator has been ignored to allow a straight left-to-right reading of the phrase.

However, as evidenced by the above example, due to the fact that different strategies at different times may produce better translations than others it is difficult to implement a single, catch-all strategy. Instead, the approach undertaken is to apply several of the strategies concurrently to produce several different translations for any item of code being processed. The results of the strategy which is known, through testing, to provide the best translations for the majority of the time will automatically form the auto-generated comment text for code in question when it is placed within a resultant Design-CodeRepresentation object. The results of the other strategies will also be placed inside the same Design-CodeRepresentation object to be available to design views should they wish to offer alternative suggestions to users for automatically generated comments and allow the user to select one. Otherwise, the user is able to manually enter their own translation.

Improvements and modifications may be incorporated herein without deviating from the scope of the invention.

1. A method for improving the development and/or review of a computer program, the method comprising the steps of:
adapting one or more design side components of the computer program to send and receive information on changes that occur therein;
adapting one or more code side components of the computer program to send and receive information on changes that occur therein;
synchronising design side components and code side components by
conveying details of a change in a design side component to one or more corresponding code side components and to one or more corresponding design side components to update the contents of said components and by conveying details of a change in a code side component to one or more corresponding design side components and one or more corresponding code side components to update the contents of said components.

2. (canceled)

3. A method as claimed in claim 1, wherein the steps of conveying details to one or more code side components and one or more design side components comprises identifying and linking together corresponding code side and design side components such that the changes are sent from and to a corresponding code side and design side component only.

4-7. (canceled)

8. A method as claimed in claim 1, wherein the correspondence between a design side component and a code side component is provided by a Design-CodeRepresentation which provides an object which merges together design side and code side information.

9-10. (canceled)

11. A method as claimed in claim 8, wherein the Design-CodeRepresentation is created or incrementally updated from a code side component by parsing of corresponding program code.

12-16. (canceled)

17. A method as claimed in claim 1, wherein code side to design side synchronisation or code side to code side synchronisation is achieved by:
retrieving code from the code side that is being edited;
creating or incrementally updating corresponding Design-CodeRepresentations from the code;
providing said Design-CodeRepresentations to design side components and other code side components;
said design side and code side components are updated.

18-20. (canceled)

21. A method as claimed claim 17, wherein Design-CodeRepresentations are created or incrementally updated from program code only if it is determined that elements of the code have changed since a previous state of the code.

22. (canceled)

23. A method as claimed in claim 1, wherein code side to design side synchronisation is achieved by:
selecting code files to be monitored;
parsing the code files and creating an initial time stamp of file content and time of last modification;
detecting changes to the selected code files as and when they occur;
parsing files which have changed to create a set of Design CodeRepresentations which reflect the changes; and updating the design side representations.

24. A method as claimed in claim 23, wherein the step of detecting changes to the selected code files comprises:
monitoring the files for changes using a timer to poll the timestamps of the selected code files and comparing them to previously known time stamps.

25. (canceled)

26. A method as claimed in claim 23, wherein the step of selecting the code files to be monitored comprises, creating code files with a synchronisation link between it and corresponding design side components.

27. A method as claimed in claim 26, wherein the program code files which are to be monitored can be selected by linking the program code files location to an application.

28-30. (canceled)

31. A method as claimed in claim 1, wherein design side to code side synchronisation or design side to design side synchronisation is achieved by:
detecting changes in design information within a design side component;
creating or incrementally updating corresponding Design-CodeRepresentations from the design information;
providing said Design-CodeRepresentations to code side and design side components;
said design side and code side components are updated.

32-34. (canceled)

35. A method as claimed in claim 1, wherein code to design and design to code synchronisation is achieved by:
detecting changes to a code side or design side component;
identifying the Design-CodeRepresentation with one that reflects the previously known state of the code or design; and
merging the Design-CodeRepresentations together to create a new version of the Design-CodeRepresentation.

36. (canceled)

37. A method as claimed in claim 35, wherein the step of merging comprises:
parsing the code side component to produce a corresponding Design-CodeRepresentation object; and comparing the Design-CodeRepresentation object from the code side component with a previous version of the Design-CodeRepresentation object in order to identify modifications so as to match the content of said Design-CodeRepresentation objects.

38. A method as claimed in claim 37, wherein matching is achieved by listing candidate Design-CodeRepresentation objects, scoring the candidate against a predetermined Design-CodeRepresentation, scoring a plurality of candidates and ranking said candidates.

39-55. (canceled)

56. A method as claimed in claim 11, wherein parsing comprises the steps of:
detecting code structures within one or more lines of code;
arranging the code structures with respect to one another to create linked design code representation of the code structures to reflect the content of the code; and creating a design view from the linked design-code representations.

57. (canceled)

58. A method as claimed in claim 1, further comprising:
detecting code structure in the form of comments within the lines of code recording said comment within a Design-CodeRepresentation;
detecting code associated with the comment and recording said code within the Design-CodeRepresentation in which said comment is recorded.

59. A method as claimed in claim 1, further comprising the steps of:
detecting code;
detecting the absence of comments associated with said code; and
automatically generating comment for inclusion in a design-coderepresentation associated with the parsed code.

60. A method as claimed in claim 1, further comprising the steps of:
creating a design code representation to hold the code property for the parsed code;
applying comment generation logic to create a comment associated with the code.

61. A method as claimed in claim 60, wherein the comment generation logic is operable to:
examine the code associated with the Design-CodeRepresentation;
translate the lines of code into natural language;
place the generated natural language in a text field of the Design-CodeRepresentation.

62-79. (canceled)

80. A computer program comprising program instructions for implementing the method according to claim 1.

81. A method of parsing comprising the steps of:
detecting code structures within one or more lines of code;
arranging the code structures with respect to one another to create linked design code representation of the code structures to reflect the content of the code; and,
creating a design view from the linked design-code representations.

82. (canceled)

83. A method as claimed in claim 81, wherein the method further comprises:
detecting code structure in the form of comments within the lines of code;
recording said comment within a Design-CodeRepresentation;
detecting code associated with the comment and recording said code within the Design-CodeRepresentation in which said comment is recorded.

84. (canceled)

85. A method as claimed in claim 81, further comprising the steps of:
creating a design code representation to hold the code property for the parsed code;
applying comment generation logic to create a comment associated with the code.

86. A method as claimed in claim 85, wherein the comment generation logic:
examines the code associated with the Design-CodeRepresentation;
translates the lines of code into natural language;
places the generated natural language in a text field of the Design-CodeRepresentation.

87. A method as claimed in claim 86, wherein the comment is any non-code item that has been included in the lines of code.

88. A method as claimed in claim 81, further comprising the steps of detecting code and comments within one or more lines of code;
prioritising the detection of comments with respect to code in order to create Design-CodeRepresentations which are suitable for the creation of a design view from the Design-CodeRepresentations, such that the extent to which the functionality of the code is explained is optimised in the design view.

89. (canceled)

90. A method as claimed in claim 81, further comprising creating tags;
placing the created tags within code; and thereby determining how the associated code is parsed.

91. A computer program comprising program instructions for implementing the method according to claim 81.
